(19) United States
(12) Patent Application Publication
(10) Pub. No.: US 2004/0236064 A1
(43) Pub. Date: Nov. 25, 2004

(54) Plastic lens material, plastic lens composition, plastic lens obtained by curing the composition and process for producing the plastic lens

(76) Inventors: Kazuhiko Ooga, Oita-shi (JP); Yoshihiro Honda, Oita-shi (JP); Tsuneo Tajima, Oita-shi (JP); Kazufumi Kai, Oita-shi (JP); Hiroshi Uchida, Oita-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 10/482,436

(22) PCT Filed: Jun. 27, 2002
(86) PCT No.: PCT/JP02/06521

Related U.S. Application Data
(60) Provisional application No. 60/303,085, filed on Jul. 6, 2001.

(30) Foreign Application Priority Data
Jul. 2, 2001 (JP) 2001-201261

(51) Int. Cl. C08F 2/46; C08J 3/28

(52) U.S. Cl. 528/300; 528/308

(57) ABSTRACT

A plastic lens material comprising at least one group having formula (1) as a terminal group and a group having formula (2) as a repeating unit wherein each R¹ independently represents an allyl group or a methallyl group and each A¹ is an independent organic residue and represents one or more organic residues derived from a divalent carboxylic acid or dicarboxylic anhydride having an alicyclic structure and/or an aromatic ring structure; wherein each A² is an independent organic residue and represents one or more organic residues derived from a divalent carboxylic acid or dicarboxylic anhydride having an alicyclic structure and/or an aromatic ring structure, and each X is an independent organic residue and represents one or more organic residues derived from a polyhydric alcohol having an ether bond within the molecule, provided that X can further have a branched structure having a group of formula (1) as a terminal group and group of formula (2) as a repeating unit.

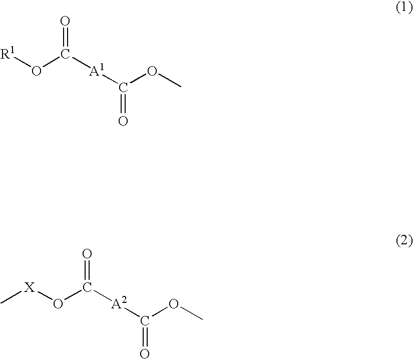

### CROSS-REFERENCE TO RELATED APPLICATIONS

This application is an application filed under 35 U.S.C. §111(a) claiming benefit pursuant to 35 U.S.C. §119(e)(1) of the filing date of the Provisional Application 60/303,085 filed Jul. 6, 2001, pursuant to 35 U.S.C. §111(b).

### TECHNICAL FIELD

The present invention relates to a plastic lens material, a plastic lens composition, a plastic lens obtained by curing the composition and a process for producing the plastic lens.

More specifically, the present invention relates to a plastic lens material, a plastic lens composition containing the material, which has a viscosity suitable for application to spectacle lens and other optical lenses and can provide a cured material having a high refractive index and a low specific gravity, a plastic lens obtained by curing the composition, and a process for producing the plastic lens.

### BACKGROUND ART

Organic glasses are lightweight as compared with inorganic glasses and therefore, organic glasses comprising a polymer such as diethylene glycol bis(allyl carbonate) or methyl methacrylate, represented by CR-39 (registered trademark) (trade name, produced by PPG), have been heretofore used. However, these organic glasses are disadvantageous in that the refractive index is from 1.49 to 1.50 and relatively low as compared with inorganic glasses (refractive index of white crown glass: 1.523), the thickness is larger than the inorganic glasses and cancels the effect of reducing the weight, and when used as a lens for visual acuity correction, the higher degree of myopia gives worse looking.

In order to solve these problems, various organic glasses using a diallyl phthalate-based monomer have been proposed. However, these are fragile or have a problem in the transmittance. If this monomer is diluted with a monofunctional polymerizable monomer so as to improve these properties, the resistance against heat or solvent is impaired and insufficient capability as an organic glass results.

An allyl ester having an allyl ester group at the terminal and having in the inside thereof the following structure derived from a polyvalent saturated carboxylic acid and a polyhydric saturated alcohol is known.

CH₂═CHCH₂O{CORCOOB′O}ₚCORCOOCH₂CH═CH₂

wherein R represents an organic residue derived from a divalent carboxylic acid having 1 to 20 carbon atoms, B′ represents a divalent organic residue derived from an alkanediol, and p represents a number of 1 to 20.

This allyl ester provides a cured material having excellent impact resistance as compared with an organic glass using a diallyl phthalate-based monomer. However, even in this case, since an aliphatic hydrocarbon is used for the moiety B′ in the inside, when p in the formula is a small number, the impact resistance is inferior to CR-39 (registered trademark). If p in the formula is set to a large number so as to attain impact resistance comparable to CR-39 (registered trademark), excessively high viscosity disadvantageously results.

The present inventors have proposed the following allyl ester oligomer in Japanese Unexamined Patent Publication No. 3-258821 (JP-A-3-258821).

CH₂═CHCH₂O{CORCOOC′O}_{q}CORCOOCH₂CH═CH₂

wherein R represents an organic residue derived from an aromatic dicarboxylic acid, C′ represents a divalent organic residue derived from a polyalkylene glycol, and q represents a number of 1 to 20.

However, it is not disclosed to use this allyl ester oligomer for plastic lens materials.

As described, for example, in Kino Zairvo (Functional Materials), Jul. of 1998, Vol. 18, No. 7, pages 33 to 40, published by CMC (Jun. 5, 1998), the material in general used as a plastic lens material must have excellent balance in various physical properties such as cutting and polishing property, resistance against chemicals, heat, impact and weather, handling workability and specific gravity, in addition to optical properties such as refractive index and Abbe number.

From the information disclosed in JP-A-3-258821, the resin is presumed to have excellent cutting and polishing property and high resistance against chemicals because this is a heat-curable resin. However, since optical properties such as refractive index and Abbe number, and physical properties such as heat resistance and impact resistance are not disclosed at all, it cannot be determined whether the resin can be used as a plastic lens material, and the present invention is not taught by this patent publication.

### DISCLOSURE OF INVENTION

It is an object of the present invention to provide a plastic lens material having excellent balance among the heat resistance, the impact resistance and the refractive index, a plastic lens composition having a viscosity suitable for the application to spectacle lens and other optical lenses and capable of giving a cured material having a high refractive index and a small specific gravity, a plastic lens obtained by curing the composition, and a process for producing the plastic lens.

As a result of extensive investigations to solve the above-described problems, the present inventors have found that when a (meth)allyl ester compound having an organic residue derived from a dicarboxylic acid having a specific structure and an organic residue derived from a polyhydric alcohol having a specific structure is used for a plastic lens material, a composition containing the plastic lens material can provide a plastic lens composition having a viscosity suitable for the application to spectacle lens and other optical lenses, a medium refractive index (refractive index n_{D}>1.54), a small specific gravity and good balance in the impact resistance and heat resistance. The present invention has been accomplished based on this finding.

More specifically, the present invention (I) provides a plastic lens material comprising at least one group represented by the following formula (1) as a terminal group and a group represented by the following formula (2) as a repeating unit:

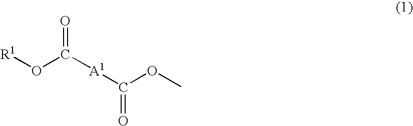

wherein each R¹ independently represents an allyl group or a methallyl group and each A¹ is an independent organic residue and represents one or more organic residues derived from a divalent carboxylic acid or dicarboxylic anhydride having an alicyclic structure and/or an aromatic ring structure;

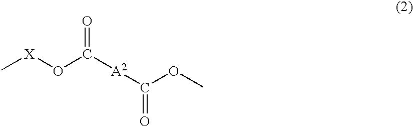

wherein each A² is an independent organic residue and represents one or more organic residues derived from a divalent carboxylic acid or dicarboxylic anhydride having an alicyclic structure and/or an aromatic ring structure, and each X is an independent organic residue and represents one or more organic residues derived from a polyhydric alcohol having an ether bond within the molecule, provided that X can further have a branched structure having a group represented by formula (1) as a terminal group and a group represented by formula (2) as a repeating unit.

The present invention (II) provides a plastic lens composition comprising a plastic lens material according to the present invention (I) and the following component (β):

Component (β)

at least one compound selected from compounds represented by the following formula (3):

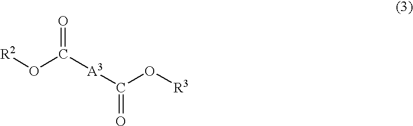

wherein R² and R³ each independently represents an allyl group or a methallyl group and A³ represents an organic residue derived from a divalent carboxylic acid or dicarboxylic anhydride having an alicyclic structure and/or an aromatic ring structure.

The present invention (III) provides a plastic lens composition comprising a plastic lens material according to the present invention (I), the following component (β) and the following component (γ):

Component (β)

at least one compound selected from compounds represented by the above formula (3);

Component (γ)

at least one compound selected from compounds represented by the following formula (4):

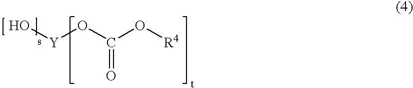

wherein Y represents one or more organic residues derived from a polyhydric alcohol having 2 to 20 carbon atoms and containing n hydroxyl groups, n represents an integer of 2 to 6, each R⁴ independently represents an allyl group or a methallyl group, s is an integer of 0 to n-1, t is an integer of 1 to n, and s+t=n.

The present invention (IV) provides a plastic lens composition comprising a plastic lens material according to the present invention (I), the following component (β) and the following component (δ):

Component (β)

at least one compound selected from compounds represented by the above formula (3);

Component (δ)

at least one monofunctional compound.

The present invention (V) provides a plastic lens composition comprising a plastic lens material according to the present invention (I), the following component (β), the following component (γ) and the following component (δ):

Component (β)

at least one compound selected from the compounds represented by the above formula (3);

Component (γ)

at least one compound selected from the compounds represented by the above formula (4);

Component (δ)

at least one monofunctional compound.

The present invention (VI) provides a plastic lens composition according to any one of the present invention (II) to the present invention (V), wherein at least one radical polymerization initiator is contained in an amount of 0.1 to 10 parts by weight per 100 parts by weight of all curable components in the plastic lens composition of any one of the present invention (II) to the present invention (V).

The term “all curable components” as used herein refers to the total amount of radical polymerizable components contained in each of the plastic lens compositions of the present invention (II) to the present invention (VI).

The present invention (VII) provides a plastic lens obtained by curing a plastic lens composition according to any one of the present invention (II) to the present invention (VI).

The present invention (VIII) provides a process for producing a plastic lens by curing a plastic lens composition according to any one of the present invention (II) to the present invention (VI).

### BRIEF DESCRIPTION OF THE DRAWINGS

Figures as attached are a 400 MHz ¹H-NMR spectrum chart and an FT-IR spectrum chart of the plastic lens materials described in production examples.

FIG. 1 is a 400 MHz ¹H-NMR spectrum chart of the allyl ester compound produced in Production Example 1.

FIG. 2 is an FT-IR spectrum chart of the allyl ester compound produced in Production Example 1.

FIG. 3 is a 400 MHz ¹H-NMR spectrum chart of the allyl ester compound produced in Production Example 2.

FIG. 4 is an FT-IR spectrum chart of the allyl ester compound produced in Production Example 2.

FIG. 5 is a 400 MHz ¹H-NMR spectrum chart of the allyl ester compound produced in Production Example 3.

FIG. 6 is an FT-IR spectrum chart of the allyl ester compound produced in Production Example 3.

### BEST MODE FOR CARRYING OUT THE INVENTION

The present invention is described in detail below.

The plastic lens material of the present invention (I) is described below.

The present invention (I) is a plastic lens material comprising at least one group represented by the above formula (1) as a terminal group and a group represented by the above formula (2) as a repeating unit.

In formula (1), each R¹ independently represents an allyl group or a methallyl group.

In formula (1), each A¹ is an independent organic residue and represents one or more organic residues derived from a divalent carboxylic acid or dicarboxylic anhydride having an alicyclic structure and/or an aromatic ring structure.

In formula (2), each A² is an independent organic residue and represents one or more organic residues derived from a divalent carboxylic acid or dicarboxylic anhydride having an alicyclic structure and/or an aromatic ring structure.

Furthermore, in formula (2), each X is an independent organic residue and represents one or more organic residues derived from a polyhydric alcohol having an ether bond within the molecule, provided that by ester bonding, X can further have a branched structure having a group represented by formula (1) as a terminal group and a group represented by formula (2) as a repeating unit.

In formula (1), each R¹ independently represents an allyl group or a methallyl group. Furthermore, in formula (1), each A¹ is an independent organic residue and represents one or more organic residues derived from a divalent carboxylic acid or dicarboxylic anhydride having an alicyclic structure and/or an aromatic ring structure. In formula (2), each A² is an independent organic residue and represents one or more organic residues derived from a divalent carboxylic acid or dicarboxylic anhydride having an alicyclic structure and/or an aromatic ring structure.

The term “each R¹ independently represents an allyl group or a methallyl group” as used herein refers to that the moieties represented by R¹ in the terminal group represented by formula (1) contained in the plastic lens material of the present invention may be all an allyl group or a methallyl group or may be partially an allyl group with the remaining being a methallyl group.

The term “each A¹ is an independent organic residue” as used herein refers to that in the following formula (5) which is one example of the plastic lens material of the present invention (I), A¹s in the number of k each is an independent organic residue:

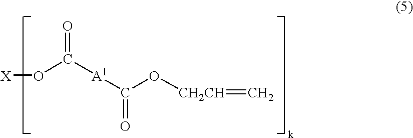

wherein each A¹ is an independent organic residue and represents an organic residue derived from a divalent carboxylic acid or dicarboxylic anhydride having an alicyclic structure and/or an aromatic ring structure, each X is an independent organic residue and represents one or more organic residues derived from a polyhydric alcohol having an ether bond within the molecule, and k represents an integer of 1 or more.

In formula (5), for example, A¹s in the number of k all may be organic residues derived from divalent carboxylic acids or dicarboxylic anhydrides having different alicyclic structures and/or aromatic ring structures (that is, one organic residue is derived from individual divalent carboxylic acids or dicarboxylic anhydrides having k kinds of alicyclic structures and/or aromatic ring structures) or all may be organic residues derived from divalent carboxylic acids or dicarboxylic anhydrides having the same alicyclic structure and/or aromatic ring structure (that is, organic residues in the number of k are derived from divalent carboxylic acids or dicarboxylic anhydrides having one kind of alicyclic structure and/or aromatic ring structure). It is also possible that some of A¹s in the number of k are organic residues derived from divalent carboxylic acids or dicarboxylic anhydrides having the same alicyclic structure and/or aromatic ring structure and some others are organic residues derived from divalent carboxylic acids or dicarboxylic anhydrides having another kind of alicyclic structure and/or aromatic ring structure.

The term “in formula (2), each A² is an independent organic residue, as used herein refers to that in the following formula (6) which is one example of the plastic lens material of the present invention (I), A²s in the number of m each is an independent organic residue.

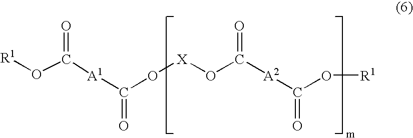

wherein one A¹ and A²s in the number of m each is an independent organic residue and represents one or more organic residues derived from a divalent carboxylic acid or dicarboxylic anhydride having an alicyclic structure and/or an aromatic ring structure, Xs in the number of m each is an independent organic residue and represents one or more organic residues derived from a divalent alcohol having an ether bond within the molecule, and m represents an integer of 1 or more.

In formula (6), for example, A²s in the number of m all may be organic residues derived from divalent carboxylic acids or dicarboxylic anhydrides having different alicyclic structures and/or aromatic ring structures (that is, one organic residue is derived from individual divalent carboxylic acids or dicarboxylic anhydrides having m kinds of alicyclic structures and/or aromatic ring structures) or all may be organic residues derived from divalent carboxylic acids or dicarboxylic anhydrides having the same alicyclic structure and/or aromatic ring structure (that is, organic residues in the number of m are derived from divalent carboxylic acids or dicarboxylic anhydrides having one kind of alicyclic structure and/or aromatic ring structure). It is also possible that some of A²s in the number of m are organic residues derived from divalent carboxylic acids or dicarboxylic anhydrides having the same alicyclic structure and/or aromatic ring structure and some others are organic residues derived from divalent carboxylic acids or dicarboxylic anhydrides having another kind of alicyclic structure and/or aromatic ring structure. Furthermore, in this mixed structure, the whole may be completely random or a part may be repeated.

The term “A¹ represents one or more organic residues derived from a divalent carboxylic acid or dicarboxylic anhydride having an alicyclic structure and/or an aromatic ring structure” as used herein refers to that in formula (5) which is one example of the plastic lens material of the present invention (I), A¹s in the number of k are partially or entirely an organic residue derived from a divalent carboxylic acid or dicarboxylic anhydride having an alicyclic structure and/or an aromatic ring structure.

In formula (5), for example, A¹s in the number of k all may be an organic residue derived from a divalent carboxylic acid or dicarboxylic anhydride having an alicyclic structure and/or an aromatic ring structure (that is, organic residues in the number of k are derived from a divalent carboxylic acid or dicarboxylic anhydride having an alicyclic structure and/or an aromatic ring structure) or may have a mixed structure where some of A¹s in the number of k are an organic residue derived from a divalent carboxylic acid or dicarboxylic anhydride having an alicyclic structure and/or an aromatic ring structure and some others are an organic residue derived from a different kind of compound.

The term “A² represents one or more organic residues derived from a divalent carboxylic acid or dicarboxylic anhydride having an alicyclic structure and/or an aromatic ring structure” as used herein refers to that in formula (6) which is one example of the plastic lens material of the present invention (I), A²S in the number of m are partially or entirely an organic residue derived from a divalent carboxylic acid or dicarboxylic anhydride having an alicyclic structure and/or an aromatic ring structure.

In formula (6), for example, A²S in the number of m all may be an organic residue derived from a divalent carboxylic acid or dicarboxylic anhydride having an alicyclic structure and/or an aromatic ring structure (that is, organic residues in the number of m are derived from a divalent carboxylic acid or dicarboxylic anhydride having an alicyclic structure and/or an aromatic ring structure) or may have a mixed structure where some of A¹s in the number of m are an organic residue derived from a divalent carboxylic acid or dicarboxylic anhydride having an alicyclic structure and/or an aromatic ring structure and some others are an organic residue derived from a different kind of compound. Furthermore, in this mixed structure, the whole may be completely random or a part may be repeated.

Hereinafter “A¹” and “A²” are collectively referred to as “A”. Examples of the “organic residue derived from a divalent carboxylic acid or dicarboxylic anhydride having an alicyclic structure and/or an aromatic ring structure, include organic residues represented by the following structural formulae (7) to (13). However, the organic residue is of course not limited to these specific examples.

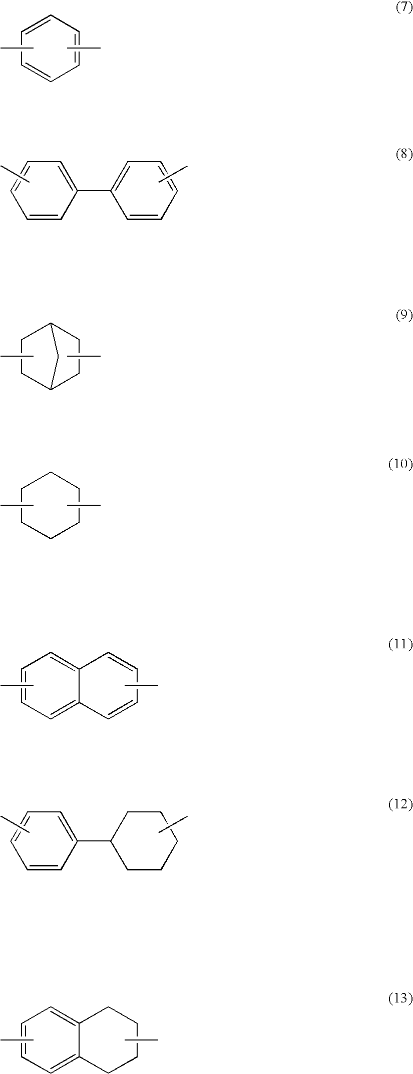

Among these, organic residues represented by formulae (7) to (9) are preferred because the high refractive index of the compound can be maintained and the compound is easily available, more preferred are a 1,4-phenylene group, a 1,3-phenylene group and a 1,2-phenylene group, and still more preferred are a 1,4-phenylene group and a 1,3-phenylene group.

Also, an organic residue derived from a divalent carboxylic acid or dicarboxylic anhydride, other than the organic residue derived from a divalent carboxylic acid or dicarboxylic anhydride having an alicyclic structure and/or an aromatic ring structure, may be contained within the molecule. This means that another divalent carboxylic acid or dicarboxylic anhydride can be used in combination with the divalent carboxylic acid or dicarboxylic anhydride having an alicyclic structure and/or an aromatic ring structure. Specific examples of the another divalent carboxylic acid or dicarboxylic anhydride include the following compounds.

Examples thereof include aliphatic dicarboxylic acids and anhydrides thereof, such as succinic acid and an anhydride thereof, glutaric acid and an anhydride thereof, adipic acid, malonic acid and an anhydride thereof, 2-methylsuccinic acid and an anhydride thereof, maleic acid and an anhydride thereof, and fumaric acid. However, needless to say, the another divalent carboxylic acid or dicarboxylic anhydride is not limited to these specific examples.

The term “each X is an independent organic residue” as used herein refers to that in the following formula (14) which is one example of the plastic lens material of the present invention, Xs in the number of v contained in the repeating unit each is an independent organic residue.

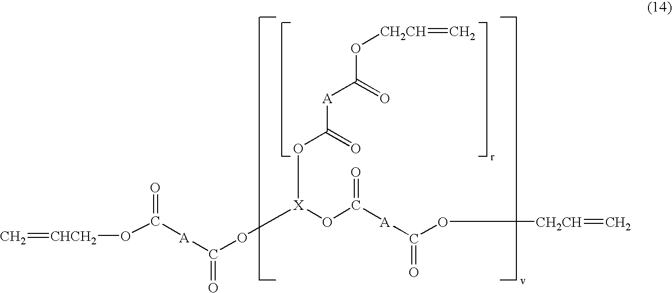

wherein each x is an independent organic residue and represents one or more organic residues derived from a polyhydric alcohol having an ether bond, v represents 0 or an integer of 1 or more, r represents 0 or an integer of 1 or more, and each A independently represents one or more organic residues derived from a divalent carboxylic acid or dicarboxylic anhydride having an alicyclic structure and/or an aromatic ring structure.

In formula (14), for example, Xs in the number of v all may be organic residues derived from different polyhydric alcohols having an ether bond (that is, one organic residue is derived from individual polyhydric alcohols of v kinds having an ether bond), all may be organic residues derived from the same compound (that is, organic residues in the number of v are derived from one kind of polyhydric alcohol having an ether bond) or may have a mixed structure where some of X's in the number of v are organic residues derived from the same compound and some others are organic residues derived from another kind of compound. Furthermore, in the mixed structure, the whole may be completely random or a part may be repeated.

The term “one or more organic residues derived from a polyhydric alcohol having an ether bond” as used herein refers to that in formula (14) which is one example of the plastic lens material of the present invention, Xs in the number of v contained in the repeating structure partially or entirely an organic residue derived from a polyhydric alcohol having an ether bond.

In formula (14), for example, Xs in the number of v all may be an organic residue derived from a polyhydric alcohol having an ether bond (that is, organic residues in the number of v are derived from a polyhydric alcohol having an ether bond) or may have a mixed structure where some of Xs in the number of v are an organic residue derived from a polyhydric alcohol having an ether bond and some others are an organic residue derived from another kind of compound. Furthermore, in the mixed structure, the whole may be completely random or a part may be repeated.

By ester bonding, X can further have a branched structure containing formula (1) as a terminal group and formula (2) as a repeating unit. More specifically, for example, when an organic residue derived from 1,1,1-tris(2-hydroxyethoxymethyl)propane as one example of a trihydric alcohol having an ether bond is present in X, the plastic lens material of the present invention (I) can have a partial structure represented by the following formula (15):

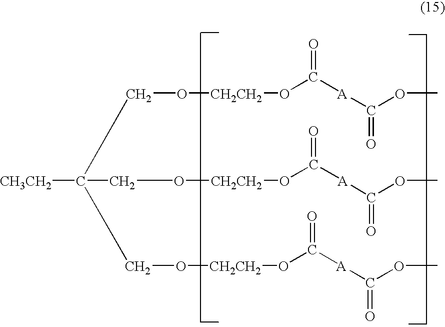

Of course, each A independently represents one or more organic residues derived from a divalent carboxylic acid or dicarboxylic anhydrides having an alicyclic structure and/or an aromatic ring structure.

In formula (2), X represents one or more organic residues derived from a polyhydric alcohol having an ether bond. Preferred examples of the “polyhydric alcohol having an ether bond” used here include the following (poly)condensates of alkane polyol. However, the polyhydric alcohol having an ether bond is not limited to these specific examples.

Examples of the dihydric alcohol include diethylene glycol, triethylene glycol, polyethylene glycols, dipropylene glycol,.tripropylene glycol, polypropylene glycols, ethylene glycol-propylene glycol (poly)condensates, and alcohols having the following structure formula (16):

HO(CH₂CH₂CH₂CH₂O)ₐ—H (16)

wherein a represents an integer of 2 or more.

Examples of the trihydric alcohol include alkylene oxide (poly)adducts of alkanetriol, such as alkylene oxide (poly)adduct of trimethylolpropane (e.g., ethylene oxide (poly)adduct of trimethylolpropane, propylene oxide (poly)adduct of trimethylolpropane, ethylene oxide-propylene oxide polyadduct of trimethylolpropane) and alkylene oxide adduct of glycerin (e.g., ethylene oxide (poly)adduct of glycerin, propylene oxide (poly)adduct of glycerin, ethylene oxide-propylene oxide polyadduct of glycerin).

Examples of the tetrahydric or greater polyhydric alcohol include alkylene oxide adducts of pentaerythritol, such as ethylene oxide (poly)adduct of pentaerythritol, propylene oxide (poly)adduct of pentaerythritol and ethylene oxide-propylene oxide polyadduct of pentaerythritol, and alkylene oxide adducts of dipentaerythritol, such as ethylene oxide (poly)adduct of dipentaerythritol, propylene oxide (poly)adduct of dipentaerythritol and ethylene oxide-propylene oxide polyadduct of dipentaerythritol.

Among these, preferred are polyethylene glycols such as diethylene glycol and triethylene glycol, polypropylene glycols such as dipropylene glycol and tripropylene glycol, ethylene glycol-propylene glycol (poly)condensates, and polyalkylene glycols such as compounds represented by formula (16), more preferred are diethylene glycol and dipropylene glycol, and most preferred is diethylene glycol.

The combination of “an organic residue derived from a divalent carboxylic acid or dicarboxylic anhydride having an alicyclic structure and/or an aromatic ring structure” and “an organic residue derived from a polyhydric alcohol having an ether bond” contained within one molecule is preferably a combination of 1,3-phenylene and/or 1,4-phenylene with an organic residue derived from diethylene glycol and/or dipropylene glycol, more preferably a combination of 1,3-phenylene and/or 1,4-phenylene with an organic residue derived from diethylene glycol, and most preferably a combination of 1,3-phenylene and 1,4-phenylene with an organic residue derived from diethylene glycol.

Together with the organic residue derived from a polyhydric alcohol having an ether bond, an organic residue derived from a polyhydric alcohol not having an ether bond may be contained within the same molecule. In other words, a polyhydric alcohol not having an ether bond can be used in combination with the polyhydric alcohol having an ether bond. Specific examples of the polyhydric alcohol not having an ether bond, which is used in combination with the polyhydric alcohol having an ether bond, include the following compounds.

Specific examples of the dihydric saturated alcohol include ethylene glycol, propylene glycol, 1,3-propanediol, 1,4-butanediol, 1,3-butanediol, neopentyl glycol, hexamethylene glycol, 1,4-cyclohexanedimethanol, p-xylylene glycol, m-xylylene glycol, o-xylylene glycol, 1,4-cyclohexanedimethanol, 1,3-cyclohexanedimethanol, 1,1-cyclohexanedimethanol and 2-methyl-1,1-cyclohexanedimethanol. Specific examples of the trihydric or greater polyhydric saturated alcohol include glycerin, trimethylolpropane, trimethylolethane, pentaerythritol, dipentaerythritol and sorbitol. However, the polyhydric alcohol not having an ether bond is not limited to these specific examples.

The repetition number of the group represented by formula (2), which is a repeating unit of the material of the present invention (I), is not particularly limited. A mixture of materials having various repetition numbers may be used. Also, a material having a repetition number of 0 and a material having a positive repetition number of 1 or more may be used in combination and this combination use is rather preferred. However, for attaining the object of the present invention, use of only a material having a repetition number of 0 is not preferred.

In the present invention, it is defined that a material having a repetition number of 0 is not included in the plastic material of the present invention (I).

More specifically, when diallyl phthalate is used as a raw material in the production of the plastic lens material of the present invention (I) and the diallyl terephthalate remains, the remaining diallyl terephthalate is not included in the plastic lens material of the present invention (I) but included in the component (β) of the present invention (II) to the present invention (VII).

Usually, the repetition number of the group represented by formula (2), which is a repeating unit of the material of the present invention (I), is preferably an integer of 1 to 50. If a plastic lens material comprising only a compound having a repetition number exceeding 50 is used for a plastic lens composition, the allyl group concentration becomes low and this may disadvantageously result in deterioration of heat resistance. The repetition number in the plastic lens material is preferably an integer of 1 to 50, more preferably from 1 to 30, still more preferably from 1 to 10.

The plastic lens material of the present invention (I) may be used alone as a plastic lens composition, but in the case of use as a plastic lens composition, the plastic lens material can be used and is preferably used in combination with other curable compound so as to reduce the viscosity or maintain the balance of other physical properties.

In the material of the present invention (I), a compound represented by formula (3) as a raw material sometimes remains, depending on the production conditions, but the plastic lens material may be used as it is.

The method for producing the plastic lens material of the present invention (I) is not particularly limited but in general, the plastic lens material of the present invention (I) can be obtained by conducting a transesterification reaction of a di(meth)allyl ester containing at least one compound represented by formula (3) with at least one polyhydric alcohol containing a polyhydric alcohol having an ether bond in the presence of a catalyst. If desired, a step such as purification may be provided.

The term “di(meth)allyl ester” as used in the present invention means a diallyl ester and/or a dimethallyl ester and/or an allylmethallyl ester.

The catalyst used in the transesterification step is not particularly limited insofar as it is a catalyst generally usable in the transesterification reaction. A metal oxide compound is particularly preferred and specific examples thereof include tetraisopropyl titanate, tetra-n-butyl titanate, di-n-butyltin oxide, di-n-octyltin oxide, hafnium acetylacetonate and zirconium acetylacetonate. However, the catalyst is not limited thereto. Among these, di-n-butyltin oxide and di-n-octyltin oxide are preferred.

The reaction temperature in this step is not particularly limited, but is preferably from 100 to 230° C., more preferably from 120 to 200° C. In particular, when a solvent is used, the reaction temperature may be limited by the boiling point thereof.

In this step, a solvent is not usually used but if desired, a solvent may be used. The solvent which can be used is not particularly limited insofar as it does not inhibit the transesterification reaction. Specific examples thereof include benzene, toluene, xylene and cyclohexane, however, the solvent is not limited thereto. Among these, benzene and toluene are preferred. However, as described above, this step can also be performed without using a solvent.

In the production of the plastic lens material of the present invention (I), the ratio charged of the di(meth)allyl ester containing at least one compound represented by formula (3) to the at least one polyhydric alcohol containing a polyhydric alcohol having an ether bond varies, depending on the valence number of polyhydric alcohol used.

However, when this is expressed by the ratio of the total number of allyl groups and methallyl groups contained in the entire amount of the di(meth)allyl ester used in the reaction to the total number of hydroxyl groups contained in the entire amount of the polyhydric alcohol used in the reaction, the ratio is preferably from 5:1 to 1.5:1, more preferably from 4:1 to 1.8:1, still more preferably from 3.5:1 to 2:1.

The plastic lens composition of the present invention (II) is described below.

The present invention (II) is a plastic lens composition comprising a plastic lens material according to the present invention (I) and the following component (β):

Component (β)

at least one compound selected from the compounds represented by formula (3).

In the plastic lens composition of the present invention (II), the plastic lens material described in the present invention (I) is used for at least one purpose selected from the purposes of maintaining and improving the refractive index, maintaining and improving the impact resistance, and improving the formability of the composition.

Component (β)

The component (β) in the plastic lens composition of the present invention (II) is described below.

In the plastic lens composition of the present invention (II), the component (β) is used for at least one purpose selected from the purposes of improving the heat resistance, maintaining and improving the refractive index, and reducing the viscosity of the composition.

The component (β) of the plastic lens composition is at least one compound selected from the compounds represented by formula (3):

In formula (3), R² and R³ each independently represents an allyl group or a methallyl group.

More specifically, R² and R³ both may be an allyl group or both may be a methallyl group, or one may be an allyl group with another being a methallyl group. However, at least one of R² and R³ is preferably an allyl group.

A³ represents an organic residue derived from a divalent carboxylic acid or dicarboxylic anhydride having an alicyclic structure and/or an aromatic ring structure.

Examples of the “organic residue derived from a divalent carboxylic acid or dicarboxylic anhydride having an alicyclic structure and/or an aromatic ring structure” used here include organic residues represented by structural formulae (7) to (13):

However, needless to say, the organic residue is not limited thereto. Among these, preferred are organic residues represented by structural formulae (7) to (9), more preferred are 1,4-phenylene group, 1,3-phenylene group and 1,2-phenylene group, still more preferred are 1,4-phenylene group and 1,3-phenylene group.

The component (β) is generally present as a residual raw material component in the production of the plastic lens material of the present invention (I), but may be added after the production of the plastic lens material of the present invention (I).

The amount of the plastic lens material of the present invention (I) blended in the plastic lens composition of the present invention (II) is preferably 10 to 90 wt %, more preferably 15 to 85 wt %, still more preferably from 20 to 80 wt %, based on all curable components in the plastic lens composition of the present invention (II).

If the amount of the plastic lens material of the present invention (I) blended in the plastic lens composition of the present invention (II) is less than 10 wt % based on all curable components in the plastic lens composition of the present invention (II), the property of the plastic lens material of the present invention (I), namely, property of improvement of impact resistance or easy formability, is not reflected on the physical properties of the cured material and this is not preferred. On the other hand, if the amount of the plastic lens material of the present invention (I) blended in the plastic lens composition of the present invention (II) exceeds 90 wt % based on all curable components in the plastic lens composition of the present invention (II), the viscosity of the composition is highly probably elevated and the heat resistance may disadvantageously deteriorate.

The amount of the component (β) blended in the plastic lens composition of the present invention (II) is preferably 10 to 90 wt %, more preferably 15 to 85 wt %, still more preferably 20 to 80 wt %, based on all curable components in the plastic lens composition of the present invention (II).

If the amount of the component (β) blended in the plastic lens composition of the present invention (II) is less than 10 wt % based on all curable components in the plastic lens composition of the present invention (II), the viscosity of the composition is highly probably elevated and the heat resistance may disadvantageously deteriorate. On the other hand, if the amount of the component (β) blended in the plastic lens composition of the present invention (II) exceeds 90 wt % based on all curable components in the plastic lens composition of the present invention (II), the property of the plastic lens material of the present invention (I), namely, property of improvement of impact resistance or easy formability, is not reflected in the physical properties of the cured material and this is not preferred.

In the plastic lens composition of the present invention (II), a curable component other than the plastic lens material of the present invention (I) and the component (β) may be added. Specific examples thereof include the component (γ) described later; the component (δ) described later; di(meth)allyl esters of aliphatic polyvalent carboxylic acid, such as di(meth)allyl maleate, di(meth)allyl succinate, di(meth)allyl itaconate, di(meth)allyl malonate, di(meth)allyl glutarate, di(meth)allyl 2-methyl succinate and di(meth)allyl adipate; tri(meth)allyl esters such as tri(meth)allyl 1,2,4-benzenetricarboxylate, tri(meth)allyl 1,3,5-benzenetricarboxylate and tri(meth)allyl 1,2,3-propanetricarboxylate; tetra(meth)allyl esters such as tetra(meth)allyl 1,2,4,5-benzenetetracarboxylate and tetra(meth)allyl 1,2,3,4-butanetetracarboxylate; and allyl ester oligomers not belonging to the category of the plastic lens material of the present invention (I). However, the curable component which may be added is of course not limited to these specific examples.

The plastic lens composition of the present invention (III) is described below.

The present invention (III) is a plastic lens composition comprising the plastic lens material according to the present invention (I), the following component (β) and the following component (γ):

Component (β)

at least one compound selected from the compounds represented by formula (3);

Component (γ)

at least one compound selected from the compounds represented by formula (4).

In the plastic lens composition of the present invention (III), the plastic lens material described in the present invention (I) is used, similarly to the case in the plastic lens composition of the present invention (II), for at least one purpose selected from the purposes of maintaining and improving the refractive index, maintaining and improving the impact resistance, and improving the formability of the composition.

In the plastic lens composition of the present invention (III), the component (β) is used, similarly to the case in the plastic lens composition of the present invention (II), for at least one purpose selected from the purposes of improving the heat resistance, maintaining and improving the refractive index, and reducing the viscosity of the composition.

Component (γ)

The component (γ) in the plastic lens composition of the present invention (III) is described below.

In the plastic lens composition of the present invention (III), the component (γ) is used for maintaining and improving the impact resistance or reducing the viscosity of the composition.

The component (γ) in the plastic lens composition of the present invention (III), namely, the compound represented by formula (4) can be produced by a known method. Examples of the method include a method of conducting a transesterification reaction between a diallyl carbonate and a polyhydric alcohol in the presence of a catalyst (see, Japanese Examined Patent Publication-No. 3-66327 (JP-B-3-66327)) and a method of reacting an allyl alcohol, a phosgene and a polyhydric alcohol while removing hydrochloric acid (see, U.S. Pat. No. 2,370,565 and No. 2,592,058). However, the method is not limited thereto.

In formula (4), Y represents an organic residue derived from a polyhydric alcohol having 2 to 20 carbon atoms and containing 2 to 6 hydroxyl groups. Examples of the “polyhydric alcohol having 2 to 20 carbon atoms and containing 2 to 6 hydroxyl groups” include the followings.

Specific examples of the dihydric alcohol include ethylene glycol, propylene glycol, 1,3-propanediol, 1,4-propanediol, 1,3-butanediol, neopentyl glycol, hexamethylene glycol, 1,3-cyclohexane dimethanol, diethylene glycol, triethylene glycol, polyethylene glycol, dipropylene glycol, tripropylene glycol, polypropylene glycol, ethylene glycol-propylene glycol (poly)condensates, and alcohols represented by formula (16).

In addition, diols having a carbonate bond or an ester bond, such as di-2-hydroxyethyl carbonate and 2-hydroxyethyl β-hydroxypropionate, may also be used.

Specific examples of the trihydric alcohol include alkylene oxide adducts of alkanetriol, such as alkylene oxide (poly)adduct of trimethylolpropane (e.g., ethylene oxide (poly)adduct of trimethylolpropane, propylene oxide (poly)adduct of trimethylolpropane, ethylene oxide·propylene oxide polyadduct of trimethylolpropane) and alkylene oxide adduct of glycerin (e.g., ethylene oxide (poly)adduct of glycerin, propylene oxide (poly)adduct of glycerin, ethylene oxide-propylene oxide polyadduct of glycerin).

Examples of the tetrahydric or greater polyhydric alcohol include alkylene oxide adducts of pentaerythritol, such as ethylene oxide (poly)adduct of pentaerythritol, propylene oxide (poly)adduct of pentaerythritol and ethylene oxide-propylene oxide polyadduct of pentaerythritol, and alkylene oxide adducts of dipentaerythritol, such as ethylene oxide (poly)adduct of dipentaerythritol, propylene oxide (poly)adduct of dipentaerythritol and ethylene oxide-propylene oxide polyadduct of dipentaerythritol. However, of course, the polyhydric alcohol having 2 to 20 carbon atoms and containing from 2 to 6 hydroxyl groups is not limited to these specific examples.

Among these polyhydric alcohols, preferred are divalent glycols. Preferred examples of the divalent glycols include ethylene glycol, propylene glycol, diethylene glycol, dipropylene glycol and di-2-hydroxyethyl carbonate. Among these, more preferred are di-2-hydroxyethyl carbonate and diethylene glycol, and most preferred is diethylene glycol. In the case where the polyhydric alcohol used is diethylene glycol, the obtained poly(allyl carbonate) is diethylene glycol bis(allyl carbonate) and specific examples thereof include CR-39 (registered trademark) (trade name, produced by PPG).

In formula (4), R⁴ represents either an allyl group or a methallyl group. Here, R⁴s are independent from each other. For example, when n=3, the compound represented by formula (3) is a mixture of compounds represented by the following formulae (17) to (19):

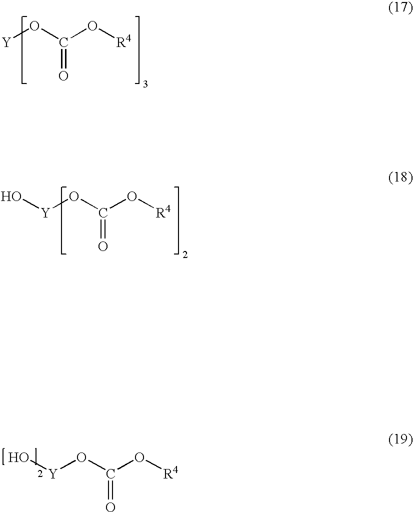

Here, for example, of the three R⁴s in formula (17), three may be an allyl group, three may be a methallyl group, two may be an allyl group with one being a methallyl group, or one may be an allyl group with two being a methallyl group. Also, of the two R⁴s in formula (18), two may be an allyl group, two may be a methallyl group, or one may be an allyl group with the remaining one being a methallyl group. R⁴ in formula (19) may be an allyl group or a methallyl group.

In formula (4), Y is an organic residue derived from a polyhydric alcohol having 2 to 20 carbon atoms and containing 2 to 6 hydroxyl group. If a compound having an organic residue derived from a polyhydric alcohol where the number of hydroxyl groups for Y is an integer exceeding 6 is used for the plastic lens composition, the plastic lens obtained by curing the composition may have poor impact resistance and this is not preferred. Furthermore, if a compound having an organic residue derived from an alcohol where the number of hydroxyl groups for Y is an integer less than 2 (namely, an integer of 1) is used for the plastic lens composition, the plastic lens obtained by curing the composition is disadvantageously reduced in resistance against heat and solvent to an extreme extent.

Assuming that the number of hydroxyl groups for Y is n, s is an integer of 0 to n-1, t is an integer of 1 to n and s+t=n. t is sufficient if it is an integer of 1 or more. However, in view of the physical properties of the final plastic lens, the carbonate group is preferably substituted by a hydroxyl group as much as possible. In the compound represented by formula (4), the compound where t=n preferably comprises 80 wt %, more preferably 90 wt %, though this varies depending on the proportion of the compound where t is less than n. If the compound where t=n is less than 80 wt %, releasability from the glass mold after molding may decrease.

The amount blended of the plastic lens material of the present invention (I) is preferably 10 to 80 wt %, more preferably 12 to 70 wt %, still more preferably 15 to 60 wt %, based on all curable components contained in the plastic lens composition of the present invention (III). If the amount blended of the plastic lens material of the present invention (I) is less than 10 wt % based on all curable components contained in the plastic lens composition of the present invention (III), the property of the plastic lens material of the present invention (I), namely, the property of enabling maintenance of refractive index, improvement of impact resistance or easy formability, is not reflected in the physical properties of the cured material and this is not preferred. On the other hand, if the amount blended of the plastic lens material of the present invention (I) exceeds 80 wt % based on all curable components in the plastic lens composition of the present invention (III), the viscosity of the composition is highly probably elevated and the heat resistance may disadvantageously deteriorate.

The amount of the component (β) blended is preferably 10 to 80 wt %, more preferably 10 to 60 wt %, still more preferably 13 to 50 wt %, based on all curable components contained in the plastic lens composition of the present invention (III). If the amount of the component (β) blended is less than 10 wt % based on all curable components contained in the plastic lens composition of the present invention (III), there is highly probably caused increase in the viscosity of the composition, deterioration of the heat resistance or decrease in the refractive index of the cured material and this is not preferred. On the other hand, if the amount of the component (β) blended exceeds 80 wt % based on all curable components in the plastic lens composition of the present invention (III), the impact resistance is highly probably deteriorated and this is not preferred.

The amount of the component (γ) blended is preferably 10 to 80 wt %, more preferably 12 to 50 wt %, still more preferably 15 to 40 wt %, based on all curable components contained in the plastic lens composition of the present invention (III). If the amount of the component (γ) blended is less than 10 wt % based on all curable components contained in the plastic lens composition of the present invention (III), this may disadvantageously result in an increase in the viscosity of the composition or decrease in the impact resistance of the cured material. On the other hand, if the amount of the component (γ) blended exceeds 80 wt % based on all curable components in the plastic lens composition of the present invention (III), the refractive index of the cured material decreases and this is not preferred.

In the plastic lens composition of the present invention (III), a curable component not belonging to any component of the plastic lens material of the present invention (I), the component (β) and the component (7), may be added. Specific examples thereof include the component (δ) described hereinbellow; di(meth)allyl esters of aliphatic polyvalent carboxylic acid, such as di(meth)allyl maleate, di(meth)allyl succinate, di(meth)allyl itaconate, di(meth)allyl malonate, di(meth)allyl glutarate, di(meth)allyl 2-methylsuccinate and di(meth)allyl adipate; tri(meth)allyl esters such as tri(meth)allyl 1,2,4-benzenetricarboxylate, tri(meth)allyl 1,3,5-benzenetricarboxylate and tri(meth)allyl 1,2,3-propanetricarboxylate; tetra(meth)allyl esters such as tetra(meth)allyl 1,2,4,5-benzenetracarboxylate and tetra(meth)allyl 1,2,3,4-butanetetracarboxylate; and allyl ester oligomers not belonging to the category of the plastic lens material of the present invention (I). However, of course, the curable component which can be added is not limited to these specific examples.

The present invention (IV) is a plastic lens composition comprising a plastic lens material according to the present invention (I), the following component (β) and the following component (δ):

Component (β)

at least one compound selected from the compounds represented by formula (3);

Component (δ)

at least one monofunctional compound. Formula (3):

In the plastic lens composition of the present invention (IV), the plastic lens material described in the present invention (I) is used, similarly to the case in the plastic lens composition of the present invention (II) or (III), for at least one purpose selected from the purposes of maintaining and improving the refractive index, maintaining and improving the impact resistance, and improving the formability of the composition.

In the plastic lens composition of the present invention (IV), the component (β) is used, similarly to the case in the plastic lens composition of the present invention (II) or (III), for at least one purpose selected from the purposes of improving the heat resistance, maintaining and improving the refractive index and reducing the viscosity of the composition.

Component (δ)

The component (δ) in the plastic lens composition of the present invention (IV) is described below.

The component (δ) in the plastic lens composition of the present invention (IV) is at least one monofunctional compound.

The term “monofunctional compound” as used herein refers to a compound having one radical polymerizable functional group within one molecule.

However, in the present invention, it is defined that the monofunctional compound belonging to the component (α) and the component (γ) is not included in the component (δ). More specifically, the compound represented by formula (19) is not included in the component (δ), but included in the component (γ).

In the plastic lens composition of the present invention (IV), the component (δ) is used for improving the impact resistance or reducing the viscosity of the composition.

Specific examples of the component (δ) in the plastic lens composition of the present invention (IV) include the following compounds.

Examples thereof include (meth)allyl benzoate, (meth)allyl p-phenylbenzoate, (meth)allyl m-phenylbenzoate, (meth)allyl o-phenylbenzoate, (meth)acryloyloxyethyl-4-phenylbenzoate, (meth)acryloyloxyethyl-3-phenylbenzoate, (meth)acryloyloxyethyl-2-phenylbenzoate, diphenyl maleate, dibenzyl maleate, dibutyl maleate, dimethoxyethyl maleate, diphenyl fumarate, dibenzyl fumarate, (meth)allyl α-naphthoate, (meth)allyl β-naphthoate, (meth)acryloyloxyethyl-α-naphthalene carboxylate, (meth)acryloyloxyethyl-β-naphthalene carboxylate, (meth)allyl o-chlorobenzoate, (meth)allyl m-chlorobenzoate, (meth)allyl p-chlorobenzoate, (meth)allyl 2,6-dichlorobenzoate, (meth)allyl 2,4-dichlorobenzoate, (meth)allyl 2,4,6-trichlorobenzoate, (meth)allyl o-bromobenzoate, (meth)allyl m-bromobenzoate, (meth)allyl p-bromobenzoate, (meth)allyl 2,6-dibromobenzoate, (meth)allyl 2,4-dibromobenzoate, (meth)allyl 2,4,6-tribromobenzoate, methyl (meth)acrylate, isobornyl (meth)acrylate, benzyl (meth)acrylate, phenyl (meth)acrylate, vinyl acetate and vinyl benzoate. However, of course, the component (δ) is not limited to these specific examples.

The amount blended of the plastic lens material of the present invention (I) is preferably 10 to 80 wt %, more preferably 12 to 70 wt %, still more preferably 15 to 65 wt %, based on all curable components contained in the plastic lens composition of the present invention (IV). If the amount blended of the plastic lens material of the present invention (I) is less than 10 wt % based on all curable components contained in the plastic lens composition of the present invention (IV), the property of the plastic lens material of the present invention (I), namely, property of enabling maintenance of refractive index, improvement of impact resistance or easy formability, is not reflected in the physical properties of the cured material and this is not preferred. On the other hand, if the amount of the plastic lens material of the present invention (I) blended in the plastic lens composition of the present invention (IV) exceeds 80 wt % based on all curable components in the plastic lens composition of the present invention (IV), the viscosity of the composition is highly probably elevated and this is not preferred.

The amount of the component (β) blended is preferably 10 to 80 wt %, more preferably 10 to 65 wt %, still more preferably 13 to 60 wt %, based on all curable components contained in the plastic lens composition of the present invention (IV). If the amount of the component (β) blended is less than 10 wt % based on all curable components contained in the plastic lens composition of the present invention (IV), there is highly probably caused increase in the viscosity of the composition, deterioration of the heat resistance or decrease in the refractive index of the cured-material and this is not preferred. On the other hand, if the amount of the component (β) blended exceeds 80 wt % based on all curable components in the plastic lens composition of the present invention (IV), the impact resistance is highly probably deteriorated and this is not preferred.

The amount of the component (δ) blended is preferably 1 to 20 wt %, more preferably 1 to 15 wt %, still more preferably 1 to 10 wt %, based on all curable components contained in the plastic lens composition of the present invention (IV). If the amount of the component (δ) blended is less than 1 wt % based on all curable components contained in the plastic lens composition of the present invention (IV), the effect resulting from the addition of the component (δ) is almost not reflected in the cured material. On the other hand, if the amount of the component (δ) blended exceeds 20 wt % based on all curable components in the plastic lens composition of the present invention (IV), the heat resistance of the cured material may deteriorate and this is not preferred.

In the plastic lens composition of the present invention (IV), a curable component not belonging to any component of the plastic lens material of the present invention (I), the component (β) and the component (δ), may be added. Specific examples thereof include the component (γ); di(meth)allyl esters of aliphatic polyvalent carboxylic acid, such as di(meth)allyl maleate, di(meth)allyl succinate, di(meth)allyl itaconate, di(meth)allyl malonate, di(meth)allyl glutarate, di(meth)allyl 2-methylsuccinate and di(meth)allyl adipate; tri(meth)allyl esters such as tri(meth)allyl 1,2,4-benzenetricarboxylate, tri(meth)allyl 1,3,5-benzenetricarboxylate and tri(meth)allyl 1,2,3-propanetricarboxylate; tetra(meth)allyl esters such as tetra(meth)allyl 1,2,4,5-benzenetracarboxylate and tetra(meth)allyl 1,2,3,4-butanetetracarboxylate; and allyl ester oligomers not belonging to the category of the plastic lens material of the present invention (I). However, of course, the curable component which can be added is not limited to these specific examples.

The present invention (V) is a plastic lens composition comprising a plastic lens material according to the present invention (I), the following component (β) the following component (γ) and the following component (δ);

Component (β)

at least one compound selected from the compounds represented by formula (3);

Component (γ)

at least one compound selected from the compounds represented by formula (4);

Component (δ)

at least one monofunctional compound.

In the plastic lens composition of the present invention (V), the plastic lens material described in the present invention (I) is used, similarly to the case in the plastic lens composition of the present invention (II) to the present invention (IV), for at least one purpose selected from the purposes of maintaining and improving the refractive index, maintaining and improving the impact resistance, and improving the formability of the composition.

In the plastic lens composition of the present invention (V), the component (β) is used, similarly to the case in the plastic lens composition of the present invention (II) to the present invention (IV), for at least one purpose selected from the purposes of improving the heat resistance, maintaining and improving the refractive index and reducing the viscosity of the composition.

In the plastic lens composition of the present invention (V), the component (γ) is used, similarly to the case in the plastic lens composition of the present invention (III), for maintaining and improving the impact resistance or reducing the viscosity of the composition.

In the plastic lens composition of the present invention (V), the component (δ) is used, similarly to the case in the plastic lens composition of the present invention (IV), for improving the impact resistance or reducing the viscosity of the composition.

The amount blended of the plastic lens material of the present invention (I) is preferably 10 to 80 wt %, more preferably 11 to 70 wt %, still more preferably 12 to 60 wt %, based on all curable components contained in the plastic lens composition of the present invention (V). If the amount blended of the plastic lens material of the present invention (I) is less than 10 wt % based on all curable components contained in the plastic lens composition of the present invention (V), the property of the plastic lens material of the present invention (I), namely, property of enabling maintenance of refractive index, improvement of impact resistance or easy formability, is not reflected on the physical properties of the cured material and this is not preferred. On the other hand, if the amount of the plastic lens material of the present invention (I) blended in the plastic lens composition of the present invention (V) exceeds 80 wt % based on all curable components in the plastic lens composition of the present invention (V), the viscosity of the composition is highly probably elevated and this is not preferred.

The amount of the component (β) blended is preferably 8 to 80 wt %, more preferably 10 to 60 wt %, still more preferably 12 to 50 wt %, based on all curable components contained in the plastic lens composition of the present invention (V). If the amount of the component (β) blended is less than 10 wt % based on all curable components contained in the plastic lens composition of the present invention (V), there is highly probably caused increase in the viscosity of the composition, deterioration of the heat resistance or decrease in the refractive index of the cured material and this is not preferred. On the other hand, if the amount of the component (β) blended exceeds 80 wt % based on all curable components in the plastic lens composition of the present invention (V), the impact resistance is highly probably deteriorated and this is not preferred.

The amount of the component (γ) blended is preferably 8 to 80 wt %, more preferably 10 to 50 wt %, still more preferably 12 to 40 wt %, based on all curable components contained in the plastic lens composition of the present invention (V). If the amount of the component (γ) blended is less than 10 wt % based on all curable components contained in the plastic lens composition of the present invention (V), this may disadvantageously result in an increase in the viscosity of the composition or a decrease in the impact resistance of the cured material. On the other hand, if the amount of the component (γ) blended exceeds 80 wt % based on all curable components in the plastic lens composition of the present invention (III), the refractive index of the cured material decreases and this is not preferred.

The amount of the component (δ) blended is preferably 1 to 20 wt %, more preferably 1 to 15 wt %, still more preferably 1 to 10 wt %, based on all curable components contained in the plastic lens composition of the present invention (V). If the amount of the component (δ) blended is less than 1 wt % based on all curable components contained in the plastic lens composition of the present invention (V), the effect by the addition of the component (δ) is almost not reflected in the cured material. On the other hand, if the amount of the component (δ) blended exceeds 20 wt % based on all curable components in the plastic lens composition of the present invention (V), the heat resistance of the cured material may deteriorate and this is not preferred.

In the plastic lens composition described in any one of the present invention (II) to the present invention (V), an ultraviolet absorbent or a light stabilizer may be added for the purpose of improving the weather resistance of the plastic lens.

The ultraviolet absorbent or the light stabilizer is not particularly limited insofar as it can be blended in the composition, but specific examples thereof include the following compounds. However, the ultraviolet absorbent or the light stabilizer is of course not limited to these specific examples.

The “ultraviolet absorbent” as used herein refers to a material which absorbs light energy of sunlight or fluorescent light and converts it into heat energy or the like. The “light stabilizer” as used herein refers to a material which traps radicals generated due to photooxidation deterioration.

Specific examples of the ultraviolet absorbent include the compounds having a benzotriazole structure unit shown in the following structural formulae.

Examples of the compound having a benzotriazole structure unit include the compounds represented by the following structural formulae (20) to (35):

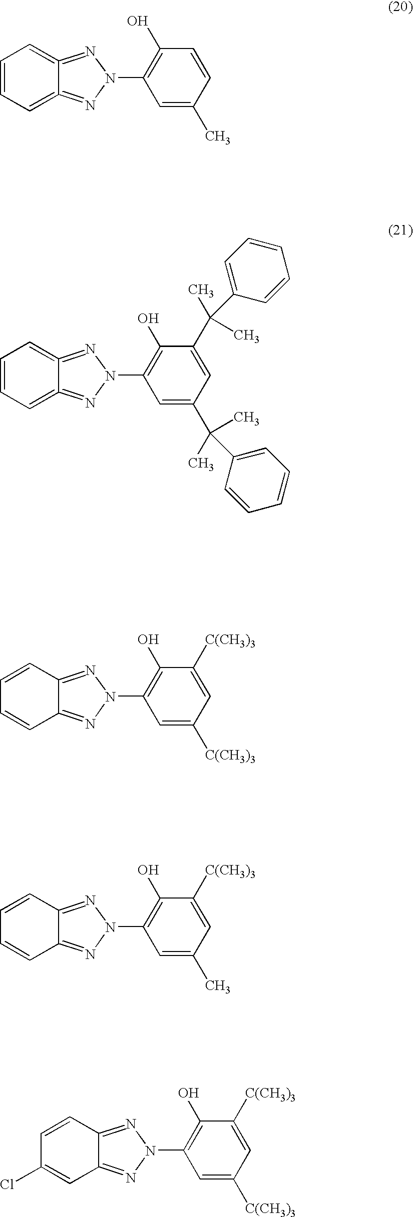

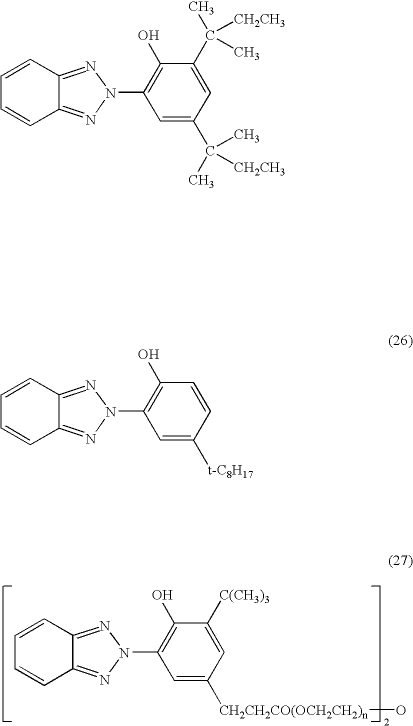

wherein n is an integer.

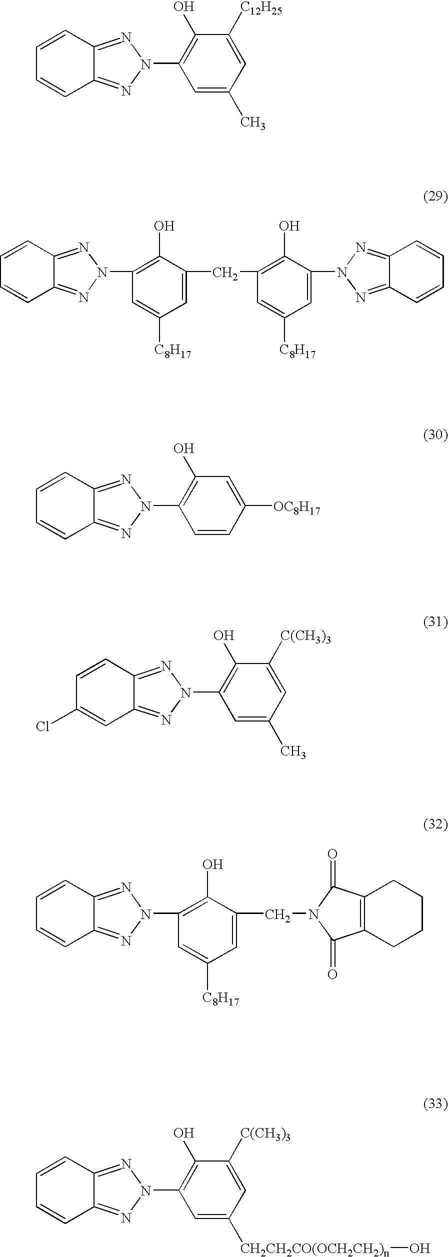

wherein n is an integer.

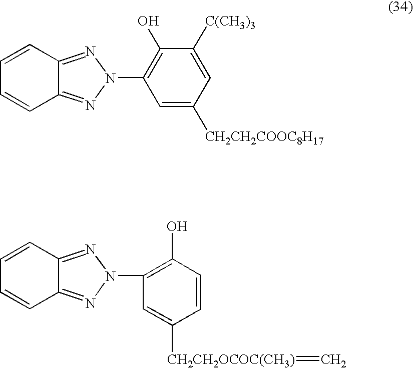

### Examples of the benzophenone-based ultraviolet absorbent include the compounds represented by the following structural formulae (36) to (40):

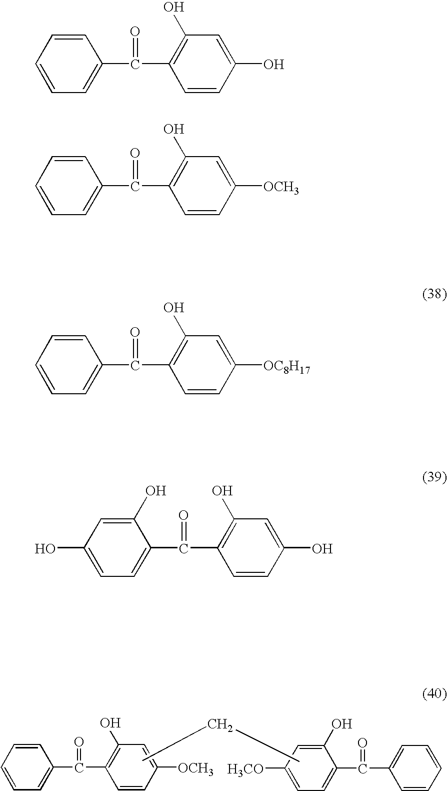

In addition, triazine-based ultraviolet absorbents represented by the following structural formula (41), oxanilide-based ultraviolet absorbents represented by the following structural formula (42), cyanoacrylate-based ultraviolet absorbents represented by the following structural formulae (43) and (44) and salicylate-based ultraviolet absorbents represented by the following structural formula (45) may also be used.

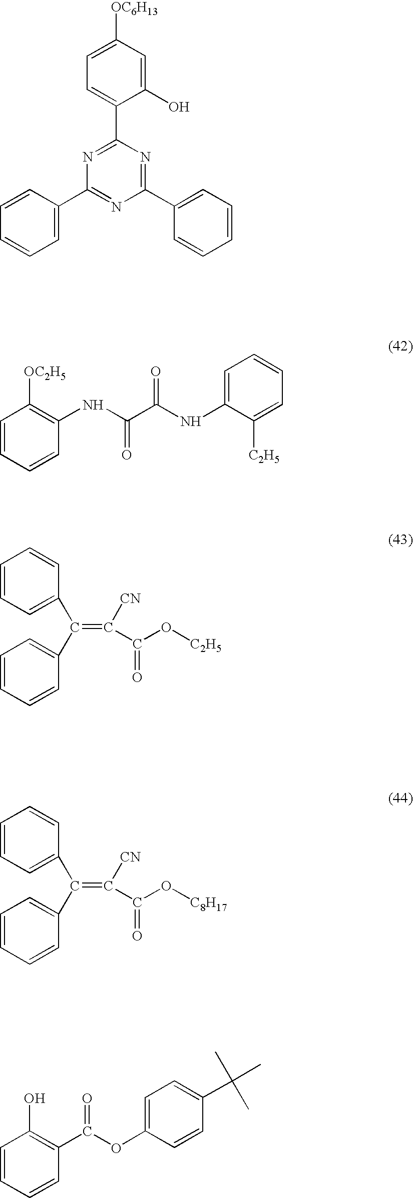

Specific examples of the light stabilizer include hindered amine-based light stabilizers represented by the following structural formulae (46) to (53), (55) and (57) to (60).

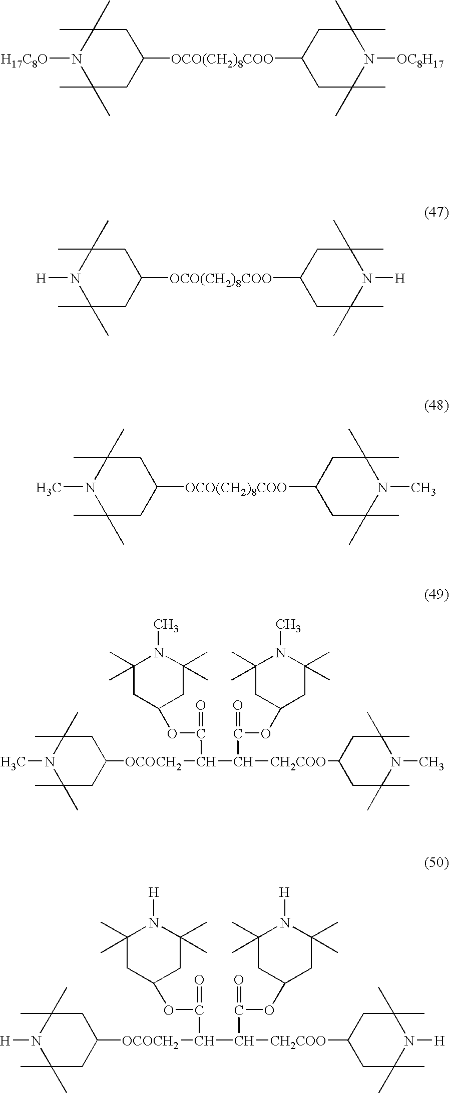

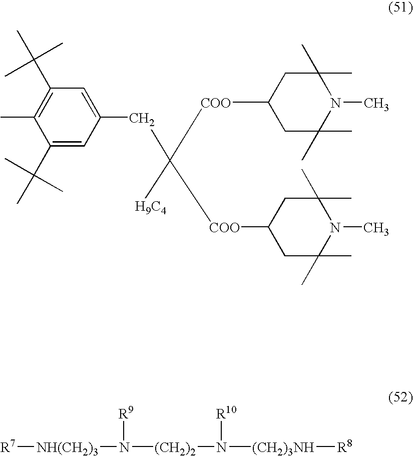

wherein R⁷, R⁸, R⁹ and R¹⁰ each represents —H or

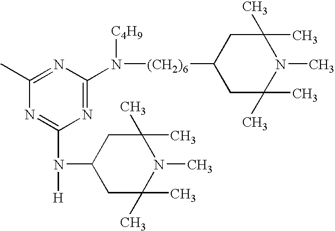

provided that the case where R⁷, R⁸, R⁹ and R¹⁰ all are a hydrogen atom is excluded.

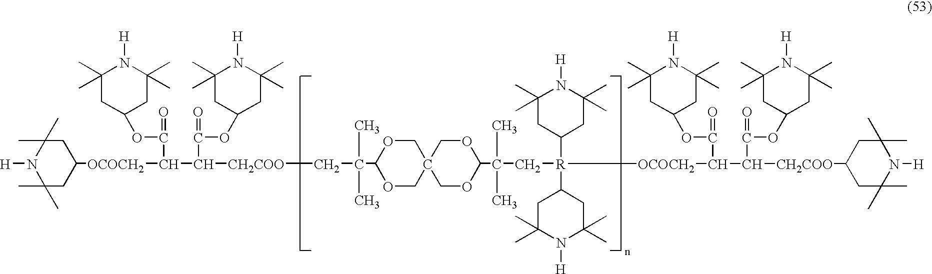

In structural formula (53), R is an organic residue represented by the following structural formula (54) and n is an integer.

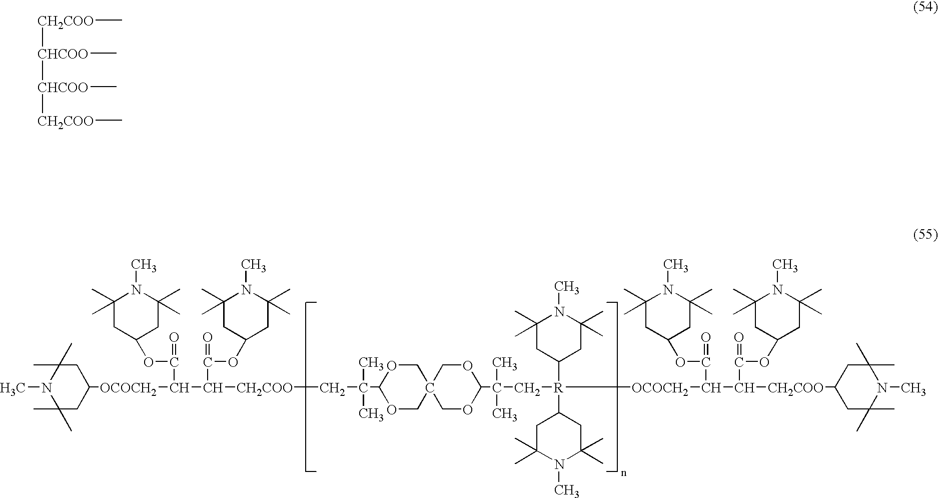

In structural formula (55), R is an organic residue represented by the following structural formula (56) and n is an integer.

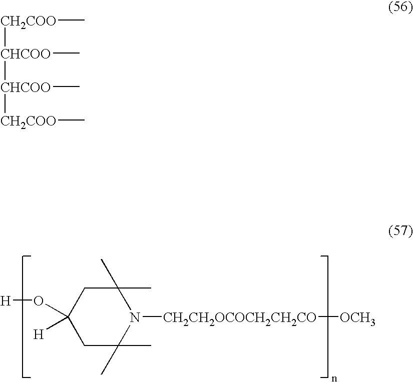

wherein n is an integer.

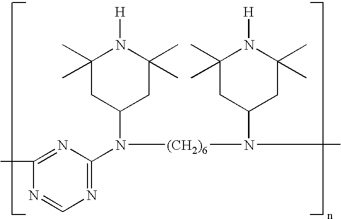

wherein n is an integer.

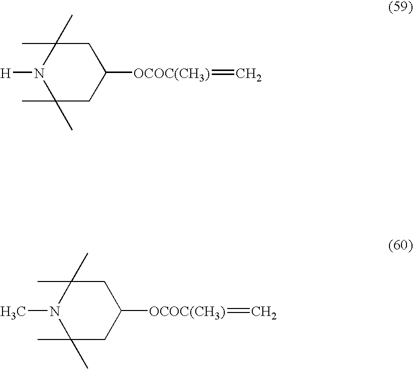

The ultraviolet absorbent and the light stabilizer may be used in combination. The ultraviolet absorbent or light stabilizer is preferably used in an amount of 0.001 to 3 wt %, more preferably from 0.01 to 1.5 wt %, based on all curable components. If the amount added is less than 0.001 wt %, the effect of preventing deterioration cannot be fully brought out and also, use in excess of 3 wt % is not preferred in view of coloration at the curing or profitability.

In the plastic lens composition of the present invention (II) to the present invention (V), additives generally used for improving the capability of plastic lens, such as a coloring agent (e.g., dye, pigment), a mold-releasing agent and antioxidant, may be added.

Examples of the coloring agent include organic pigments such as anthraquinone type, azo type, carbonium type, quinoline type, quinoneimine type, indigoid type and phthalocyanine type; organic dyes such as azoic dye and sulfur dye; and inorganic pigments such as titanium yellow, yellow iron oxide, zinc yellow, chrome orange, molybdenum red, cobalt violet, cobalt blue, cobalt green, chromium oxide, titanium oxide, zinc sulfide and carbon black. However, needless to say, the coloring agent is not limited to these specific examples.

Examples of the mold-releasing agent include stearic acid, butyl stearate, zinc stearate, stearic acid amide, fluorine-containing compounds and silicone compounds. However, the mold-releasing agent is of course not limited to these specific examples.

Examples of the antioxidant which can be used include general phenol-based antioxidant, phosphite-based antioxidant and thioether-based antioxidant.

Specific examples of the phenol-based antioxidant include the following compounds of structural formulae (61) to (70).

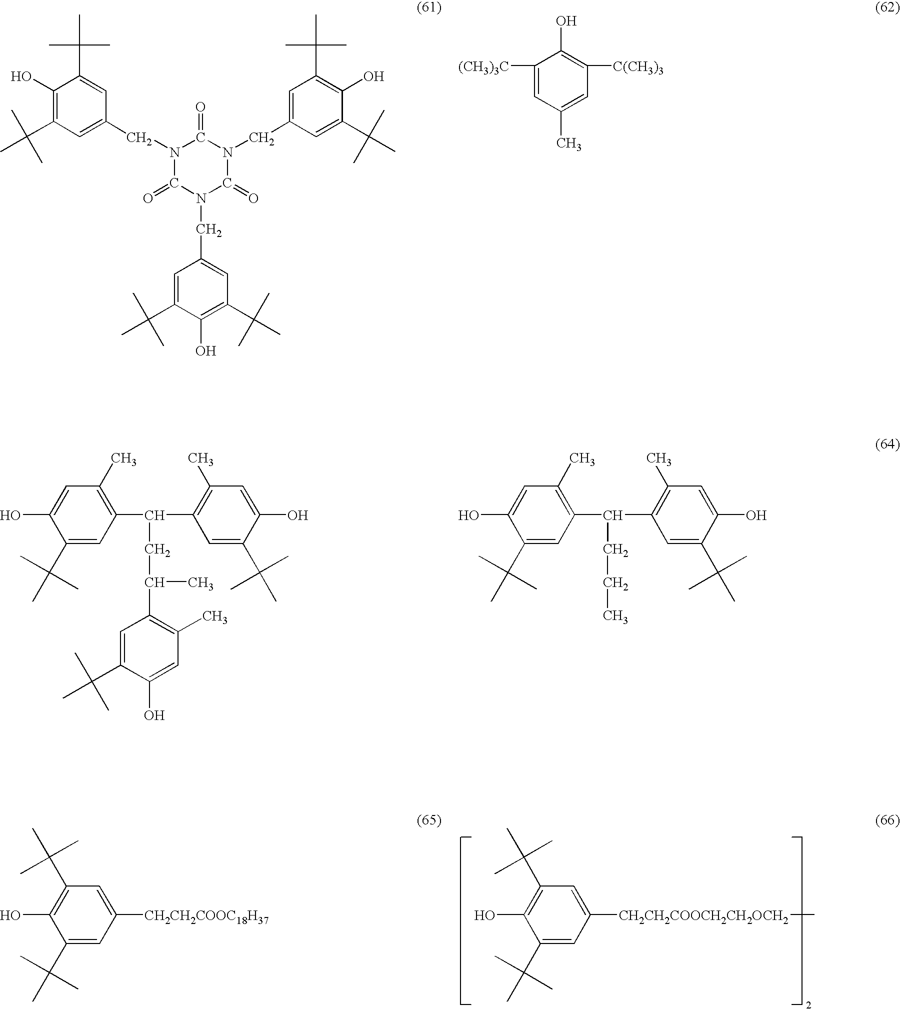

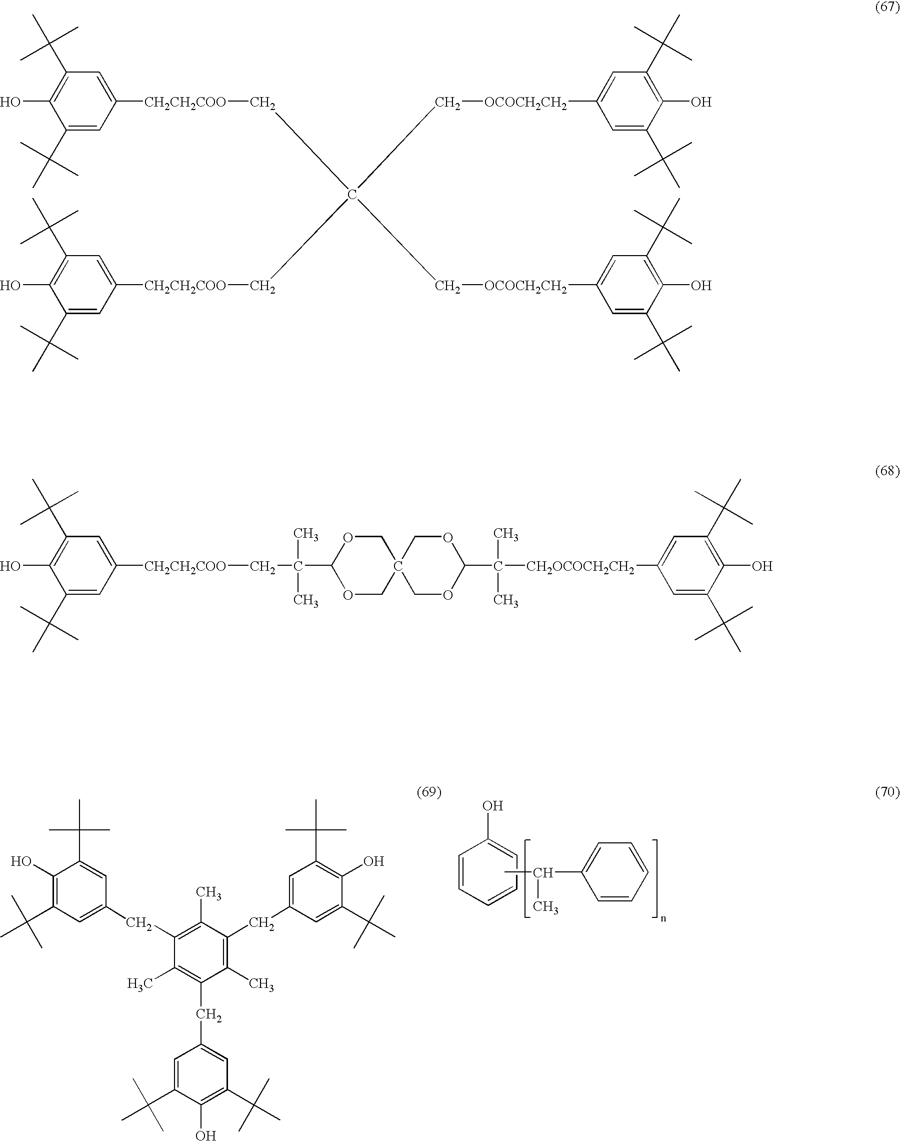

wherein n is an integer of 1 to 5.

Specific examples of the phosphite-based antioxidant include the following compounds of structural formulae (71) to (82).

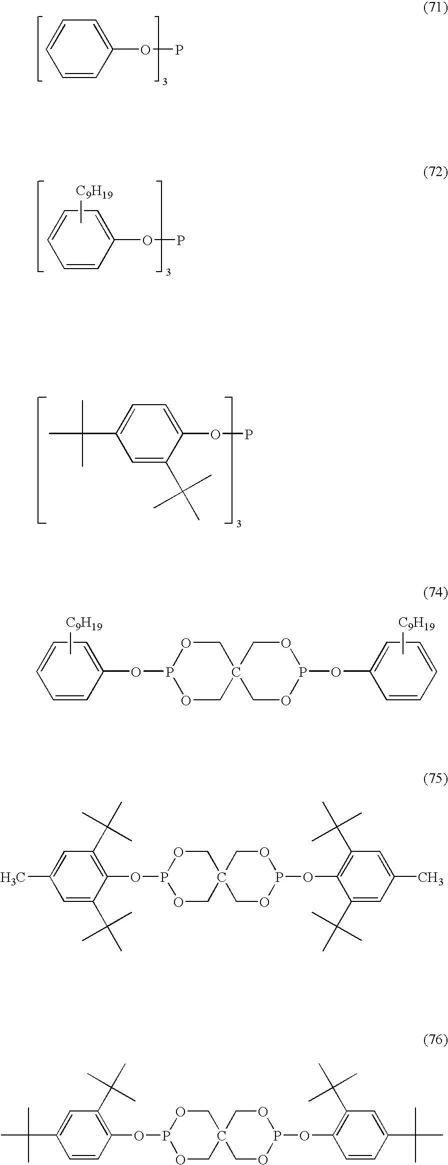

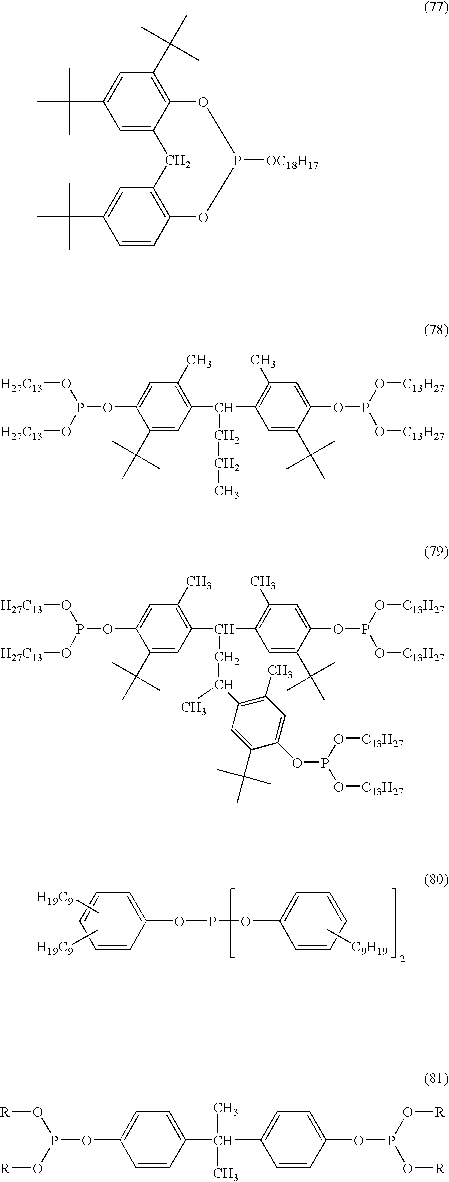

wherein R is a C₁₂-C₁₅ alkyl group.

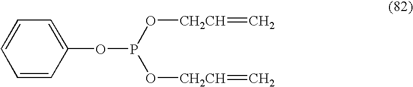

Specific examples of the thioether-based antioxidant include the following compounds of structural formulae (83) to (88).

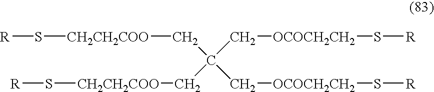

wherein R is a C₁₂-C₁₅ alkyl group.

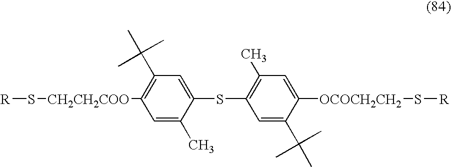

wherein R is a C₁₂-C₁₅ alkyl group.

H₂₅C₁₂—OCOCH₂CH₂—S—CH₂CH₂COO—C₁₂H₂₅ (85)

H₂₇C₁₃—OCOCH₂CH₂—S—CH₂CH₂COO—C₁₃H₂₇ (86)

H₂₉C₁₄—OCOCH₂CH₂—S—CH₂CH₂COO—C₁₄H₂₉ (87)

H₃₇C₁₈—OCOCH₂CH₂—S—CH₂CH₂COO—C₁₈H₃₇ (88)

The antioxidant may be used in combination with the ultraviolet absorbent or light stabilizer.

The amount of the antioxidant used is preferably 0.01 to 5 wt %, more preferably 0.1 to 3 wt %, based on all curable components. If the amount added is less than 0.01 wt %, the effect of preventing the deterioration cannot be fully brought out and also, use in excess of 5 wt % is disadvantageous in view of profitability.

In the plastic lens composition of the present invention, a fluorescent brightening agent such as 2,5-bis[5-tert-butylbenzoxazolyl(2)]thiophene (compound of the following structural formula (89)) may be added.

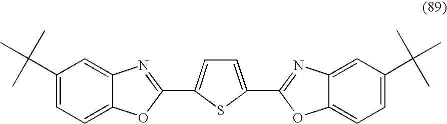

The plastic lens composition of the present invention (VI) is described below.

The present invention (VI) is a plastic lens composition according to any one of the present invention (II) to the present invention (V), wherein at least one radical polymerization initiator is contained in an amount of 0.1 to 10 parts by weight per 100 parts by weight of all curable components in the plastic lens composition described in any one of the present invention (II) to the present invention (V).

In the plastic lens composition according to any one of the present invention (II) to the present invention (V), a radical polymerization initiator as a curing agent can be and is preferably added.

The radical polymerization initiator which can be added to the plastic lens composition according to any one of the present invention (II) to the present invention (V) is not particularly limited. A known radical polymerization initiator may also be used insofar as it does not adversely affect the physical values such as optical properties of the plastic lens obtained by curing the composition.

The radical polymerization initiator for use in the present invention is, however, preferably soluble in other components present in the composition to be cured and at the same time, generates free radicals at 30 to 120° C. Specific examples of the radical polymerization initiator which can be added include, but are not limited to, diisopropylperoxy dicarbonate, dicyclohexylperoxy dicarbonate, di-n-propylperoxy dicarbonate, di-sec-butylperoxy dicarbonate and tert-butyl perbenzoate. In view of curability, radical polymerization initiators having a structure represented by the following formula (90) are preferred.

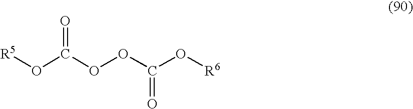

wherein R⁵ and R⁶ each independently represents at least one group selected from the group consisting of an alkyl group having 1 to 10 carbon atoms, a substituted alkyl group, a phenyl group and a substituted phenyl group.

In the formula, R⁵ and R⁶ each independently represents at least one group selected from the group consisting of an alkyl group having 1 to 10 carbon atoms, a substituted alkyl group, a phenyl group and a substituted phenyl group.

Specific examples of the radical polymerization initiator represented by formula (90) include di-n-propylperoxy dicarbonate, diisopropylperoxy dicarbonate, bis(4-tert-butylcyclohexyl)peroxy dicarbonate, di-2-ethoxyethylperoxy dicarbonate, di-2-ethylhexylperoxy bicarbonate, di-3-methoxybutylperoxy dicarbonate, di-sec-butylperoxy dicarbonate and di(3-methyl-3-methoxybutyl)peroxy dicarbonate. Among these, preferred are di-n-propylperoxy dicarbonate, diisopropylperoxy dicarbonate, di-2-ethoxyethylperoxy dicarbonate, di-2-ethylhexylperoxy dicarbonate and di(3-methyl-3-methoxybutyl)peroxy bicarbonate, more preferred is diisopropylperoxy dicarbonate.

The amount of the radical polymerization initiator added is 0.1 to 10 parts by weight, preferably 1 to 5 parts by weight, per 100 parts by weight of all curable components contained in the plastic lens composition of the present invention (II) to the present invention (V). If the amount added is less than 0.1 part by weight, the curing of the composition may insufficiently proceed. Also, the addition in excess of 10 parts by weight is not preferred in view of profitability.

On considering the filterability and the cast working of the composition, the viscosity at 25° C. of the plastic lens composition of the present invention (II) to the present invention (V) is generally 1,000 mPa.s or less, preferably 500 mPa.s or less, still more preferably 400 mPa.s or less.

The “viscosity” as used herein is a value measured by a rotational viscometer and the details on the rotational viscometer are described in Iwanami Rikagaku Jiten. Dai 3-Pan (Encyclopedia of Physics and Chemistry, 3rd Ed.), 3rd ed., 8th imp., page 212 (Jun. 1, 1977).

The present invention (VII) and the present invention (VIII) are described below.

The present invention (VII) is a plastic lens obtained by curing a plastic lens composition according to any one of the present invention (II) to the present invention (VI).

The present invention (VIII) is a process for producing a plastic lens by curing a plastic lens composition according to any one of the present invention (II) to the present invention (VI).

In the present invention, the mold-processing of the plastic lens composition is suitably performed by cast molding. More specifically, a molding method of adding a radical polymerization initiator to the composition, filling the composition into a mold fixed by an elastomer gasket or spacer through a line, and heat-curing it in an oven may be used.

The construction material of the mold here is a metal or glass. In general, the mold for plastic lenses must be cleaned after the cast-molding and such cleaning is usually performed using a strong alkali solution or a strong acid. Unlike metal, glass is little changed in quality by the cleaning and can be easily polished and thereby greatly reduced in surface roughness. For these reasons, glass is preferably used.

The curing temperature at the time of molding the plastic lens composition described in any one of the present invention (II) to the present invention (VI) is about 30 to 120° C., preferably 40 to 100° C. Taking account of shrinkage or strain at the curing, the curing temperature is preferably operated by a method of allowing the curing to gradually proceed while elevating the temperature. The curing time is generally 0.5 to 100 hours, preferably 3 to 50 hours, more preferably 10 to 30 hours.

The plastic lens of the present invention can be dyed, similarly to normal plastic lenses.

The method for dyeing the plastic lens of the present invention is not particularly limited and any method may be used insofar as it is a known dyeing method for plastic lenses. Among these, a dip dyeing method conventionally known as a general method is preferred. The “dip dyeing method” as used herein means a method of dispersing a disperse dye together with a surfactant in water to prepare a dyeing solution and dipping a plastic lens in this dyeing solution under heating, thereby dyeing the plastic lens.

The method for dyeing the plastic lens is not limited to this dip dyeing method but other known methods may also be used, for example, a method of sublimating an organic pigment and thereby dyeing a plastic lens (see, Japanese Examined Patent Publication No. 35-1384 (JP-B-35-1384)) or a method of sublimating a sublimable dye and thereby dyeing a plastic lens (see, Japanese Examined Patent Publications No. 56-159376 (JP-B-56-159376) and No. 1-277814 (JP-B-1-277814)). In view of simple operation, the dip dyeing method is most preferred.

The present invention will further be illustrated by referring to the Examples. However, the present invention should not be construed as being limited thereto.

Various physical properties were measured as follows.

1. Refractive Index (n_{D}) and Abbe Number

A test piece of 9 mm×16 mm×4 mm was prepared and measured on the refractive index (n_{D}) and Abbe number (ν_{D}) at 25° C. using “Abbe Refractometer 1T” manufactured by Atago. The contact solvent used was α-bromonaphthalene.

2. Viscosity

The viscosity was measured at a measurement temperature of 25° C. by a B-Type Viscometer (Model BU8) manufactured by Tokyo Keiki Co., Ltd.

3. Barcol Hardness

The Barcol hardness was measured using Model 934-1 according to JIS K 6911.

4. Charpy Impact Value

The Charpy impact value was measured according to JIS K 7111.

5. Measurement of Glass Transition Point (Tg)

The glass transition point was measured using TMA/SS120, DISC STATION SSC/5200H (manufactured by Seiko Instruments).

6. Measurement of Specific Gravity of Cured Material

The specific gravity of the cured material after the curing was measured by the sink-float method (at 23° C.) described in JIS K 7112.

### PRODUCTION EXAMPLE 1

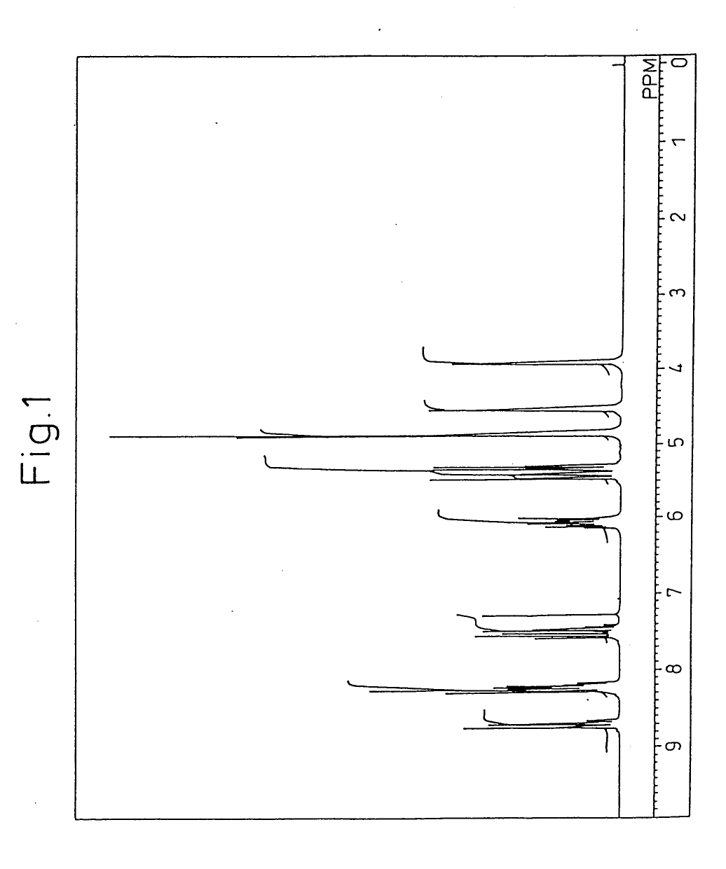

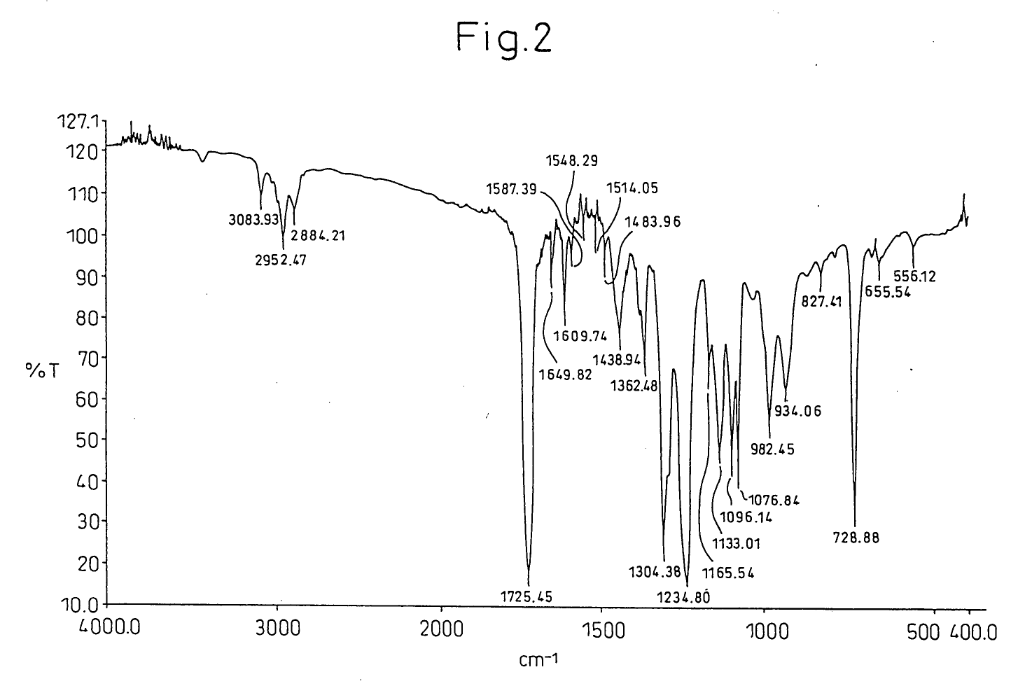

Into a 3 liter three-neck flask with a distillation unit, 1,847.0 g (7.5 mol) of diallyl isophthalate, 265.3 g (2.5 mol) of diethylene glycol and 0.923 g of dibutyltin oxide were charged. The system was heated at 155° C. in a nitrogen stream to distill off allyl alcohol generated. When about 232 g of allyl alcohol was distilled off, the pressure inside the reaction system was reduced to 1.33 kPa to accelerate the distillation of allyl alcohol. After a theoretical amount (290.4 g) of allyl alcohol was distilled off, the system was heated for another one hour and then kept at 160° C. and 0.13 kPa for one hour. Thereafter, the reactor was cooled, as a result, 1,821.9 g of an allyl ester compound was obtained (hereinafter referred to as “Sample A”). FIG. 1 and FIG. 2 show 270 MHz ¹H-NMR spectrum (solvent: CDCl₃) and FT-IR spectrum of Sample A, respectively.

Sample A was analyzed by gas chromatography (GC-14B manufactured-by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 42 wt % of diallyl isophthalate.

### PRODUCTION EXAMPLE 2

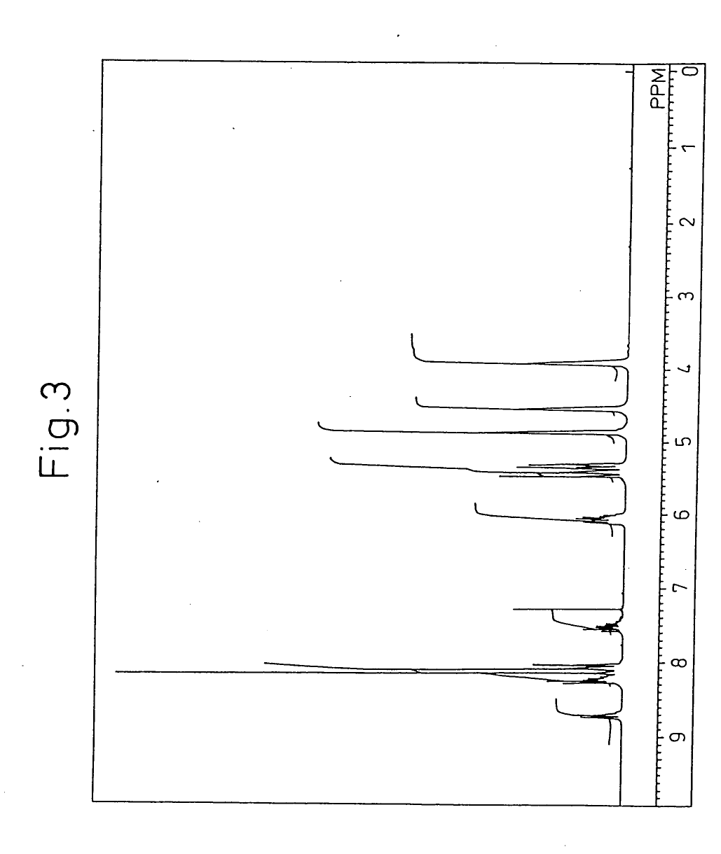

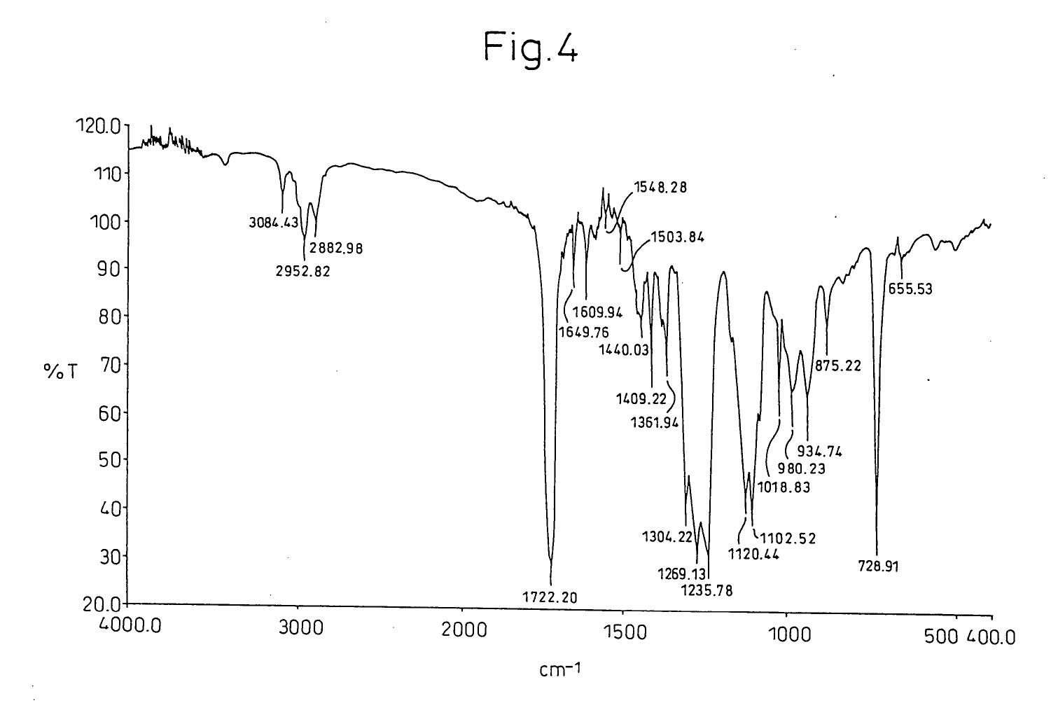

Into a 3 liter three-neck flask with a distillation unit, 738.8 g (3.0 mol) of diallyl isophthalate, 738.8 g (3.0 mol) of diallyl terephthalate, 254.7 g (2.4 mol) of diethylene glycol and 0.739 g of dibutyltin oxide were charged. The system was heated at 160° C. in a nitrogen stream to distill off allyl alcohol generated. When about 223 g of allyl alcohol was distilled off, the pressure inside the reaction system was reduced to 1.33 kPa to accelerate the distillation of allyl alcohol. After a theoretical amount (278.8 g) of allyl alcohol was distilled off, the system was heated for another one hour and then kept at 160° C. and 0.13 kPa for one hour. Thereafter, the reactor was cooled, as a result, 1,453.5 g of an allyl ester compound was obtained (hereinafter referred to as “Sample B”). FIG. 3 and FIG. 4 show 270 MHz ¹H-NMR spectrum (solvent: CDCl₃) and FT-IR spectrum of Sample B, respectively.

Sample B was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 18 wt % of diallyl terephthalate and 19 wt % of diallyl isophthalate.

### PRODUCTION EXAMPLE 3

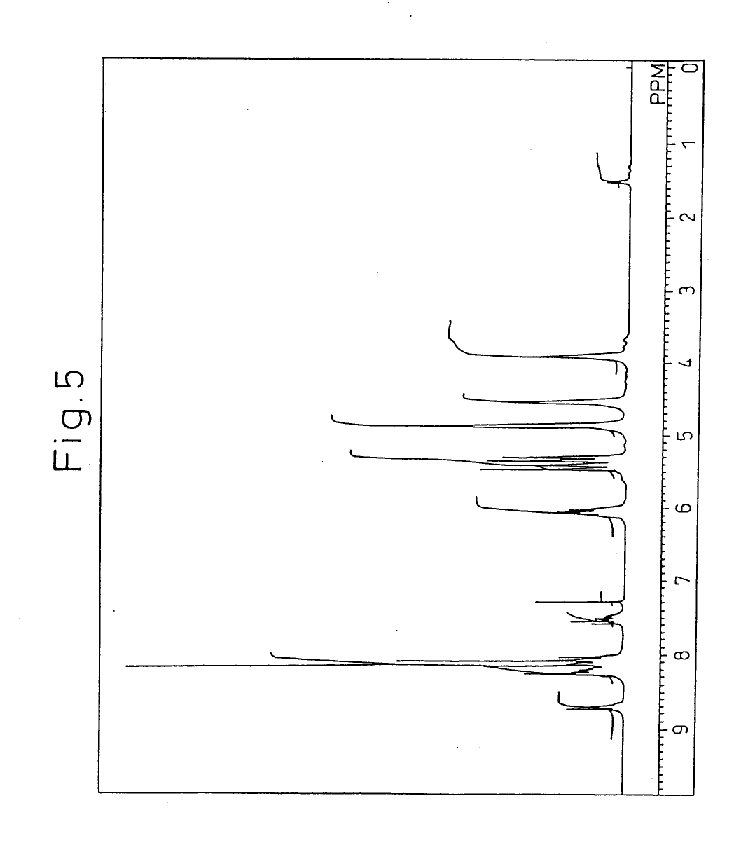

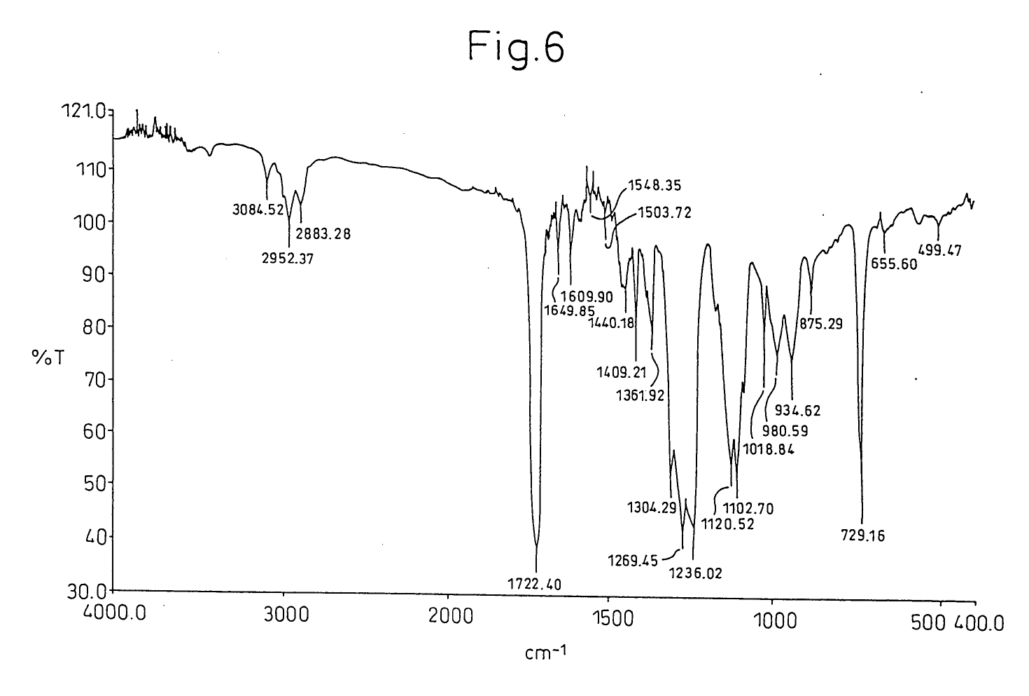

Into a 3 liter three-neck flask with a distillation unit, 738.8 g (3.0 mol) of diallyl isophthalate, 738.8 g (3.0 mol) of diallyl terephthalate, 212.2 g (2.0 mol) of diethylene glycol, 30.4 g (0.4 mol) of propylene glycol and 0.739 g of dibutyltin oxide were charged. The system was heated at 170° C. in a nitrogen stream to distill off allyl alcohol generated. When about 223 g of allyl alcohol was distilled off, the pressure inside the reaction system was reduced to 1.33 kPa to accelerate the distillation of allyl alcohol. After a theoretical amount (278.8 g) of allyl alcohol was distilled off, the system was heated for another one hour and then kept at 170° C. and 0.13 kPa for one hour. Thereafter, the reactor was cooled, as a result, 1,441.5 g of an allyl ester compound was obtained (hereinafter referred to as “Sample C”). FIG. 5 and FIG. 6 show 270 MHz ¹H-NMR spectrum (solvent: CDCl₃) and FT-IR spectrum of Sample C, respectively.

Sample C was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 19 wt % of diallyl terephthalate and 20 wt % of diallyl isophthalate.

### PRODUCTION EXAMPLE 4

Into a 3 liter three-neck flask with a distillation unit, 1,231.3 g (5.0 mol) of diallyl isophthalate, 615.7 g (2.5 mol) of diallyl terephthalate, 265.3 g (2.5 mol) of diethylene glycol and 0.923 g of dibutyltin oxide were charged. The system was heated at 170° C. in a nitrogen stream to distill off allyl alcohol generated. When about 232 g of allyl alcohol was distilled off, the pressure inside the reaction system was reduced to 1.33 kPa to accelerate the distillation of allyl alcohol. After a theoretical amount (290.4 g) of allyl alcohol was distilled off, the system was heated for another one hour and then kept at 170° C. and 0.13 kPa for one hour. Thereafter, the reactor was cooled, as a result, 1,821.9 g of an allyl ester compound was obtained (hereinafter referred to as “Sample D”).

Sample D was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 28 wt % of diallyl isophthalate and 14 wt % of diallyl terephthalate.

### PRODUCTION EXAMPLE 5

Into a 3 liter three-neck flask with a distillation unit, 1,385.2 g (5.625 mol) of diallyl isophthalate, 461.7 g (1.875 mol) of diallyl terephthalate, 265.3 g (2.5 mol) of diethylene glycol and 0.923 g of dibutyltin oxide were charged. The system was heated at 170° C. in a nitrogen stream to distill off allyl alcohol generated. When about 232 g of allyl alcohol was distilled off, the pressure inside the reaction system was reduced to 1.33 kPa to accelerate the distillation of allyl alcohol. After a theoretical amount (290.4 g) of allyl alcohol was distilled off, the system was heated for another one hour and then kept at 170° C. and 0.13 kPa for one hour. Thereafter, the reactor was cooled, as a result, 1,821.9 g of an allyl ester compound was obtained (hereinafter referred to as “Sample E”).

Sample E was analyzed by gas chromatography (GC-14B manufactured by Shimadzu Corporation,,hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 31.5 wt % of diallyl isophthalate and 10.5 wt % of diallyl terephthalate.

### PRODUCTION EXAMPLE 6

Into a 3 liter three-neck flask with a distillation unit, 1,108.2 g (4.5 mol) of diallyl terephthalate, 756.9 g (3.0 mol) of diallyl 1,4-cyclohexanedicarboxylate, 265.3 g (2.5 mol) of diethylene glycol and 0.923 g of dibutyltin oxide were charged. The system was heated at 170° C. in a nitrogen stream to distill off allyl alcohol generated. When about 232 g of allyl alcohol was distilled off, the pressure inside the reaction system was reduced to 1.33 kPa to accelerate the distillation of allyl alcohol. After a theoretical amount (290.4 g) of allyl alcohol was distilled off, the system was heated for another one hour and then kept at 170° C. and 0.13 kPa for one hour. Thereafter, the reactor was cooled, as a result, 1,821.9 g of an allyl ester compound was obtained (hereinafter referred to as “Sample F”).

Sample F was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 26 wt % of diallyl terephthalate and 16 wt % of diallyl 1,4-cyclohexanedicarboxylate.

### PRODUCTION EXAMPLE 7

Into a 3 liter three-neck flask with a distillation unit, 147.8 g (0.6 mol) of diallyl isophthalate, 1,329.8 g (5.4 mol) of diallyl terephthalate, 286.5 g (2.7 mol) of diethylene glycol and 0.739 g of dibutyltin oxide were charged. The system was heated at 170° C. in a nitrogen stream to distill off allyl alcohol generated. When about 250 g of allyl alcohol was distilled off, the pressure inside the reaction system was reduced to 1.33 kPa to accelerate the distillation of allyl alcohol. After a theoretical amount (313.6 g) of allyl alcohol was distilled off, the system was heated for another one hour and then kept at 170° C. and 0.13 kPa for one hour. Thereafter, the reactor was cooled, as a result, 1,450.5 g of an allyl ester compound was obtained (hereinafter referred to as “Sample G”).

Sample G was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 4 wt % of diallyl terephthalate and 28 wt % of diallyl isophthalate.

### PRODUCTION EXAMPLE 8

Into a 3 liter three-neck flask with a distillation unit, 295.5 g (1.2 mol) of diallyl isophthalate, 1,182.1 g (4.8 mol) of diallyl terephthalate, 254.7 g (2.4 mol) of diethylene glycol and 0.739 g of dibutyltin oxide were charged. The system was heated at 170° C. in a nitrogen stream to distill off allyl alcohol generated. When about 250 g of allyl alcohol was distilled off, the pressure inside the reaction system was reduced to 1.33 kPa to accelerate the distillation of allyl alcohol. After a theoretical amount (313.6 g) of allyl alcohol was distilled off, the system was heated for another one hour and then kept at 170° C. and 0.13 kPa for one hour. Thereafter, the reactor was cooled, as a result, 1,453.5 g of an allyl ester compound was obtained (hereinafter referred to as “Sample H”).

Sample H was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 29 wt % of diallyl terephthalate and 8 wt % of diallyl isophthalate.

### PRODUCTION EXAMPLE 9

Into a 1 liter three-neck flask with a distillation unit, 738.8 g (3.0 mol) of diallyl isophthalate, 76.1 g (1.0 mol) of propylene glycol and 0.739 g of dibutyltin oxide were charged. The system was heated at 180° C. in a nitrogen stream to distill off allyl alcohol generated. When about 81 g of allyl alcohol was distilled off, the pressure inside the reaction system was reduced to 1.33 kPa to accelerate the distillation of allyl alcohol. After a theoretical amount (116.2 g) of allyl alcohol was distilled off, the system was heated for another one hour and then kept at 180° C. and 0.13 kPa for one hour. Thereafter, the reactor was cooled, as a result, 699.0 g of an allyl ester compound was obtained (hereinafter referred to as “Sample I”).

Sample I was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 43 wt % of diallyl isophthalate.

### PRODUCTION EXAMPLE 10

Into a 1 liter three-neck flask with a distillation unit, 738.8 g (3.0 mol) of diallyl terephthalate, 76.1 g (1.0 mol) of propylene glycol and 0.739 g of dibutyltin oxide were charged. The system was heated at 180° C. in a nitrogen stream to distill off allyl alcohol generated. When about 81 g of allyl alcohol was distilled off, the pressure inside the reaction system was reduced to 1.33 kPa to accelerate the distillation of allyl alcohol. After a theoretical amount (116.2 g) of allyl alcohol was distilled off, the system was heated for another one hour and then kept at 180° C. and 0.13 kPa for one hour. Thereafter, the reactor was cooled, as a result, 699.0 g of an allyl ester compound was obtained (hereinafter referred to as “Sample J”l).

Sample J was analyzed by gas chromatography (GC-14B manufactured by Shimadzu Corporation, hydrogen flame ionization detector, column used: DB-23 having a film thickness of 0.25 μm and a length of 30 m, column temperature: constant at 130° C. for 5 minutes and after elevating to 200° C. at 5° C./min, constant at 200° C.) and found to contain 43 wt % of diallyl terephthalate.

### EXAMPLE 1

As shown in Table 1, 100.0 parts by weight of Sample A and 3 parts by weight of diisopropylperoxy dicarbonate (IPP) were blended and mixed with stirring to give a completely homogeneous solution composition. The viscosity at this time was measured. Thereafter, a vessel containing this solution was placed in a desiccator capable of depressurization and the pressure was reduced by a vacuum pump for about 15 minutes to degas the solution. The resulting solution composition was carefully injected by a syringe into a mold fabricated from a glass-made mold for ophthalmic plastic lenses and a resin-made gasket, while taking care to prevent intermixing of gas, and then cured in an oven under heating according to a temperature rising program of 40° C. for 7 hours, 40 to 60° C. for 10 hours, 60 to 80° C. for 3 hours, 80° C. for 1 hour, and 85° C. for 2 hours.

The lens obtained was measured on the refractive index, Abbe number, Barcol hardness, glass transition point (Tg), Charpy impact value and specific gravity at 23° C. The results are shown in Table 1.

TABLE 1

| | | | Example | Example | Example | Example | Comparative |
|---|---|---|---|---|---|---|---|
| | | | 1 | 2 | 3 | 4 | Example 1 |
| Formulation | Sample | Compound of structural formula (91) | 58 | | | | |
| (parts by | A | Diallyl isophthalate | 42 | | | | |
| weight) | Sample | Compound of structural formula (92) | | 58 | | | |
| | D | Diallyl isophthalate | | 28 | | | |
| | | Diallyl terephthalate | | 14 | | | |
| | Sample | Compound of structural formula (92) | | | 58 | | |
| | E | Diallyl isophthalate | | | 31.5 | | |
| | | Diallyl terephthalate | | | 10.5 | | |
| | Sample | Compound of structural formula (93) | | | | 58 | |
| | F | Diallyl terephthalate | | | | 26 | |
| | | Diallyl 1,4-cyclo- | | | | 16 | |
| | | hexanedicarboxylate | | | | | |
| | Sample | Compound of structural formula (94) | | | | | 57 |
| | J | Diallyl terephthalate | | | | | 43 |

| Viscosity (25° C.) [mPa · s] | | 350 | 340 | 344 | 199 | 550 |
|---|---|---|---|---|---|---|
| Initiator IPP [parts by weight] | | 3 | 3 | 3 | 3 | 3 |
| Physical | Refractive index n_{D} | 1.571 | 1.572 | 1.572 | 1.550 | 1.568 |
| Properties | Abbe number | 33 | 33 | 33 | 40 | 30 |
| of Cured | Barcol hardness | 40 | 42 | 41 | 31 | 43 |
| Material | Tg [° C.] | 85 | 95 | 90 | 85 | 273 |
| | Charpy impact value [kJ/m²] | 1.3 | 1.2 | 1.2 | 1.8 | 0.8 |
| | Specific gravity (23° C.) | 1.284 | 1.284 | 1.285 | 1.241 | 1.259 |

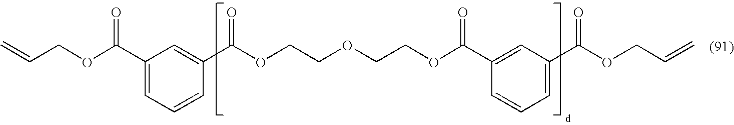

wherein d represents an integer of 1 or more.

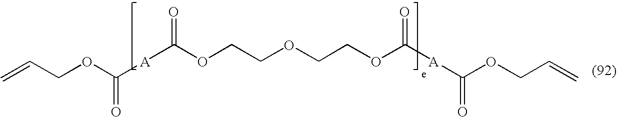

wherein each A independently represents 1,4-phenylene or
1,3-phenylene and e represents an integer of 1 or more.

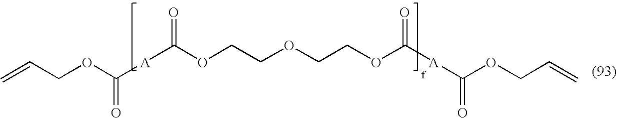

wherein each A independently represents 1,4-phenylene or
1,3-phenylene and f represents an integer of 1 or more.

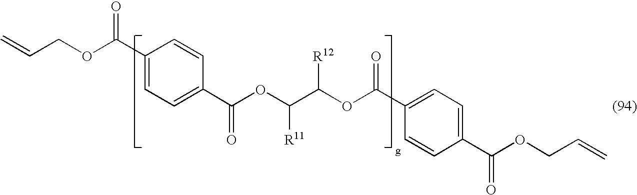

wherein one of R¹¹ and R¹² represents H, another
represents CH₃ and g represents an integer of 1 or more.

### EXAMPLES 2 to 4 and COMPARATIVE EXAMPLE 1

Compositions were prepared according to the formulations shown in Table 1 and, in the same manner as in Example 1, measured on the viscosity and then cured. The lenses obtained were measured on the refractive index, Abbe number, Barcol hardness, glass transition point (Tg), Charpy impact value and specific gravity at 23° C. The results are shown in Table 1.

### EXAMPLE 5

As shown in Table 2, 70.0 parts by weight of Sample A, 30.0 parts by weight of diethylene glycol bis(allyl carbonate) (trade name: CR-39 (registered trademark), produced by PPG) and 3 parts by weight of diisopropylperoxy dicarbonate (IPP) were blended and mixed with stirring to obtain a completely homogeneous solution composition. The viscosity at this time was measured. Thereafter, a vessel containing this solution was placed in a desiccator capable of depressurization and the pressure was reduced by a vacuum pump for about 15 minutes to degas the solution. The resulting solution composition was carefully injected by a syringe into a mold fabricated from a glass-made mold for ophthalmic plastic lenses and a resin-made gasket, while taking care to prevent intermixing of gas, and then cured in an oven under heating according to a temperature rising program of 40° C. for 7 hours, 40 to 60° C. for 10 hours, 60 to 80° C. for 3 hours, 80° C. for 1 hour, and 85° C. for 2 hours.

The lens obtained was measured on the refractive index, Abbe number, Barcol hardness, glass transition point (Tg), Charpy impact value and specific gravity at 23° C. The results are shown in Table 2.

TABLE 2

| | | | Example | Example | Example | Example | Example | Comparative |
|---|---|---|---|---|---|---|---|---|
| | | | 5 | 6 | 7 | 8 | 9 | Example 2 |
| Formulation | Sample | Compound of structural formula (91) | 40.6 | | | | | |
| (parts by | A | Diallyl isophthalate | 29.4 | | | | | |
| weight) | Sample | Compound of structural formula (92) | | 44.1 | | | | |
| | B | Diallyl isophthalate | | 13.3 | | | | |
| | | Diallyl terephthalate | | 12.6 | | | | |
| | Sample | Compound of structural formula (95) | | | 42.7 | | | |
| | C | Diallyl isophthalate | | | 14.0 | | | |
| | | Diallyl terephthalate | | | 13.3 | | | |
| | Sample | Compound of structural formula (92) | | | | 47.6 | | |
| | G | Diallyl isophthalate | | | | 2.8 | | |
| | | Diallyl terephthalate | | | | 19.6 | | |
| | Sample | Compound of structural formula (92) | | | | | 44.1 | |
| | H | Diallyl isophthalate | | | | | 5.6 | |
| | | Diallyl terephthalate | | | | | 20.3 | |
| | Sample | Compound of structural formula (96) | | | | | | 39.9 |
| | I | Diallyl isophthalate | | | | | | 31.1 |
| | CR-39 | | 30 | 30 | 30 | 30 | 30 | 30 |

| Viscosity (25° C.) [mPa · s] | | 84 | 156 | 128 | 160 | 112 | 105 |
|---|---|---|---|---|---|---|---|
| Initiator IPP [parts by weight] | | 3 | 3 | 3 | 3 | 3 | 3 |
| Physical | Refractive index n_{D} | 1.552 | 1.553 | 1.554 | 1.556 | 1.554 | 1.550 |
| Properties | Abbe number | 38 | 38 | 38 | 37 | 38 | 38 |
| of Cured | Barcol hardness | 38 | 33 | 35 | 31 | 35 | 40 |
| Material | Tg [° C.] | 83 | 85 | 90 | 85 | 85 | 100 |
| | Charpy impact value [kJ/m²] | 1.4 | 1.4 | 1.4 | 1.6 | 1.4 | 1.1 |
| | Specific gravity (23° C.) | 1.287 | 1.289 | 1.288 | 1.291 | 1.288 | 1.287 |

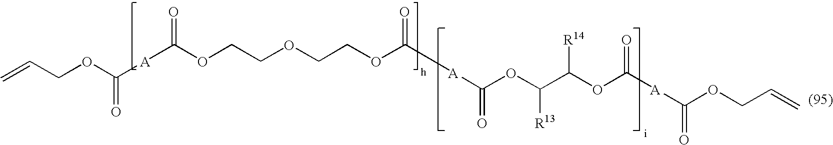

wherein one of R¹³ and R¹⁴ represents H, another
represents CH₃, each A independently represents a 1,4-phenylene
group or a 1,3-phenylene group, and h and i
each represents 0 or an integer of 1 or more, provided
that (h + i) represents an integer of 1 or more.

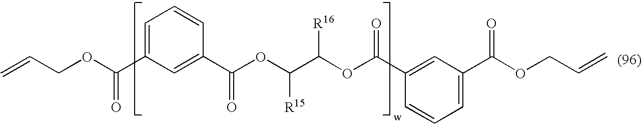

wherein one of R¹⁵ and R¹⁶ represents H, another
represents CH₃, and w represents an integer of 1 or more.

### EXAMPLES 6 to 9 and COMPARATIVE EXAMPLE 2

Compositions were prepared according to the formulations shown in Table 2 and, in the same manner as in Example 5, measured on the viscosity and then cured. The lenses obtained were measured on the refractive index, Abbe number, Barcol hardness, glass transition point (Tg), Charpy impact value and specific gravity at 23° C. The results are shown in Table 2.

### EXAMPLE 10

As shown in Table 3, 95.0 parts by weight of Sample A, 5.0 parts by weight of allyl benzoate and 3 parts by weight of diisopropylperoxy dicarbonate (IPP) were blended and mixed with stirring to give a completely homogeneous solution composition. The viscosity at this time was measured. Thereafter, a vessel containing this solution was placed in a desiccator capable of depressurization and the pressure was reduced by a vacuum pump for about 15 minutes to degas the solution. The resulting solution composition was carefully injected by a syringe into a mold fabricated from a glass-made mold for ophthalmic plastic lenses and a resin-made gasket, while taking care to prevent intermixing of gas, and then cured in an oven under heating according to a temperature rising program of 40° C. for 7 hours, 40 to 60° C. for 10 hours, 60 to 80° C. for 3 hours, 80° C. for 1 hour, and 85° C. for 2 hours.

The lens obtained was measured on the refractive index, Abbe number, Barcol hardness, glass transition point (Tg), Charpy impact value and specific gravity at 23° C. The results are shown in Table 3.

TABLE 3

| | | | | | | Comparative |
|---|---|---|---|---|---|---|
| | | | Example 10 | Example 11 | Example 12 | Example 3 |
| Formulation | Sample | Compound of structural formula (91) | 55.1 | | | |
| (parts by | A | Diallyl isophthalate | 39.9 | | | |
| weight) | Sample | Compound of structural formula (92) | | 55.1 | | |
| | D | Diallyl isophthalate | | 26.6 | | |
| | | Diallyl terephthalate | | 13.3 | | |
| | Sample | Compound of structural formula (92) | | | 55.1 | |
| | E | Diallyl isophthalate | | | 29.925 | |
| | | Diallyl terephthalate | | | 9.975 | |
| | Sample | Compound of structural formula (96) | | | | 54.15 |
| | I | Diallyl isophthalate | | | | 40.85 |

| | Allyl benzoate | 5 | 5 | 5 | 5 |
|---|---|---|---|---|---|
| Viscosity (25° C.) [mPa · s] | | 225 | 219 | 221 | 400 |
| Initiator IPP [parts by weight] | | 3 | 3 | 3 | 3 |
| Physical | Refractive index n_{D} | 1.572 | 1.573 | 1.573 | 1.570 |
| Properties | Abbe number | 33 | 33 | 33 | 33 |
| of Cured | Barcol hardness | 40 | 42 | 41 | 42 |
| Material | Tg [° C.] | 82 | 90 | 85 | 110 |
| | Charpy impact value [kJ/m²] | 1.4 | 1.3 | 1.3 | 0.9 |
| | Specific gravity (23° C.) | 1.282 | 1.282 | 1.283 | 1.257 |

### EXAMPLES 11 and 12 and COMPARATIVE EXAMPLE 3

Compositions were prepared according to the blending shown in Table 3 and, in the same manner as in Example 10, measured on the viscosity and then cured. The lenses obtained were measured on the refractive index, Abbe number, Barcol hardness, glass transition point (Tg), Charpy impact value and specific gravity at 23° C. The results are shown in Table 3.

### EXAMPLE 13

As shown in Table 4, 65.0 parts by weight of Sample A, 30.0 parts by weight of diethylene glycol bis(allyl carbonate) (trade name: CR-39 (registered trademark), produced by PPG), 5 parts by weight of allyl p-phenylbenzoate and 3 parts by weight of diisopropylperoxy dicarbonate (IPP) were blended and mixed with stirring to obtain a completely homogeneous solution composition. The viscosity at this time was measured. Thereafter, a vessel containing this solution was placed in a desiccator capable of depressurization and the pressure was reduced by a vacuum pump for about 15 minutes to degas the solution. The resulting solution composition was carefully injected by a syringe into a mold fabricated from a glass-made mold for ophthalmic plastic lenses and a resin-made gasket, while taking care to prevent intermixing of gas, and then cured in an oven under heating according to a temperature rising program of 40° C. for 7 hours, 40 to 60° C. for 10 hours, 60 to 80° C. for 3 hours, 80° C. for 1 hour, and 85° C. for 2 hours.

The lens obtained was measured on the refractive index, Abbe number, Barcol hardness, glass transition point (Tg), Charpy impact value and specific gravity at 23° C. The results are shown in Table 4.

TABLE 4

| | | | Example | Example | Example | Example | Example | Comparative |
|---|---|---|---|---|---|---|---|---|
| | | | 13 | 14 | 15 | 16 | 17 | Example 4 |
| Formulation | Sample | Compound of structural formula (91) | 37.7 | | | | | |
| (parts by | A | Diallyl isophthalate | 27.3 | | | | | |
| weight) | Sample | Compound of structural formula (92) | | 40.95 | | | | |
| | B | Diallyl isophthalate | | 12.35 | | | | |
| | | Diallyl terephthalate | | 11.7 | | | | |
| | Sample | Compound of structural formula (95) | | | 39.65 | | | |
| | C | Diallyl isophthalate | | | 13.0 | | | |
| | | Diallyl terephthalate | | | 12.35 | | | |
| | Sample | Compound of structural formula (92) | | | | 44.2 | | |
| | G | Diallyl isophthalate | | | | 2.6 | | |
| | | Diallyl terephthalate | | | | 18.2 | | |
| | Sample | Compound of structural formula (92) | | | | | 40.95 | |
| | H | Diallyl isophthalate | | | | | 5.2 | |
| | | Diallyl terephthalate | | | | | 18.85 | |
| | Sample | Compound of structural formula (94) | | | | | | 37.05 |
| | J | Diallyl terephthalate | | | | | | 27.95 |

| | CR-39 | 30 | 30 | 30 | 30 | 30 | 30 |
|---|---|---|---|---|---|---|---|
| | Allyl benzoate | 5 | 5 | 5 | 5 | 5 | 5 |
| Viscosity (25° C.) [mPa · s] | | 75 | 130 | 120 | 135 | 100 | 90 |
| Initiator IPP [parts by weight] | | 3 | 3 | 3 | 3 | 3 | 3 |
| Physical | Refractive index n_{D} | 1.552 | 1.553 | 1.554 | 1.556 | 1.554 | 1.550 |
| Properties | Abbe number | 38 | 38 | 38 | 37 | 38 | 36 |
| of Cured | Barcol hardness | 38 | 33 | 35 | 31 | 35 | 41 |
| Material | Tg [° C.] | 80 | 81 | 85 | 81 | 82 | 138 |
| | Charpy impact value [kJ/m²] | 1.4 | 1.4 | 1.4 | 1.6 | 1.4 | 1.0 |
| | Specific gravity (23° C.) | 1.286 | 1.288 | 1.287 | 1.290 | 1.287 | 1.286 |

### EXAMPLES 14 to 17 and COMPARATIVE EXAMPLE 4

Compositions were prepared according to the formulations shown in Table 4 and, in the same manner as in Example 13, measured on the viscosity and then cured. The lenses obtained were measured on the refractive index, Abbe number, Barcol hardness, glass transition point (Tg), Charpy impact value and specific gravity at 23° C. The results are shown in Table 4.

Industrial Applicability

According to the present invention, a plastic lens material having excellent balance in heat resistance, impact resistance and refractive index; a plastic lens composition having a viscosity suitable for the application to spectacle lenses or other optical lenses and capable of providing a cured material having a high refractive index and a small specific gravity; a plastic lens obtained by curing the composition; and a method for producing the plastic lens can be provided.

1. A plastic lens material comprising at least one group represented by the following formula (1) as a terminal group and a group represented by the following formula (2) as a repeating unit: 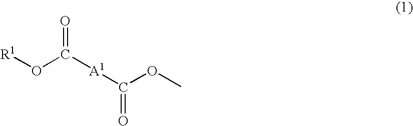
wherein each R¹ independently represents an allyl group or a methallyl group and each A¹ is an independent organic residue and represents one or more organic residues derived from a divalent carboxylic acid or dicarboxylic anhydride having an alicyclic structure and/or an aromatic ring structure; 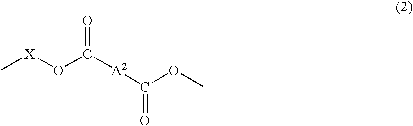
wherein each A² is an independent organic residue and represents one or more organic residues derived from a divalent carboxylic acid or dicarboxylic anhydride having an alicyclic structure and/or an aromatic ring structure, and each X is an independent organic residue and represents one or more organic residues derived from a polyhydric alcohol having an ether bond within the molecule, provided that X can further have a branched structure having a group represented by formula (1) as a terminal group and a group represented by formula (2) as a repeating unit.

2. A plastic lens material according to claim 1, wherein the polyhydric alcohol having an ether bond within the molecule is at least one member selected from the group consisting of polyalkylene glycols.

3. A plastic lens material according to claim 1 or 2, wherein the organic residue derived from a divalent carboxylic acid or dicarboxylic anhydride having an alicyclic structure and/or an aromatic ring structure is at least one member selected from the group consisting of the following structural formulae (7) to (9):

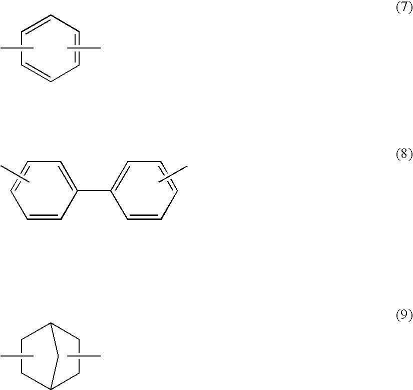

4. A plastic lens composition comprising a plastic lens material according to claim 1 and the following component (β):
Component (β)
at least one compound selected from the compounds represented by the following formula (3): 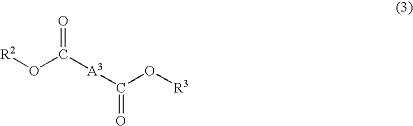
wherein R² and R³ each independently represents an allyl group or a methallyl group and A³ represents an organic residue derived from a divalent carboxylic acid or dicarboxylic anhydride having an alicyclic structure and/or an aromatic ring structure.

5. A plastic lens composition according to claim 4, which comprises from 10 to 90 wt % of the plastic lens material comprising at least one group represented by the formula (1) as a terminal group and a group represented by the formula (2) as a repeating unit and from 10 to 90 wt % of the component (β), based on all curable components.

6. A plastic lens composition comprising a plastic lens material according to claim 1, the following component (β) and the following component (γ):
Component (β)
at least one compound selected from the compounds represented by the following formula (3);
Component (γ)
at least one compound selected from the compounds represented by the following formula (4): 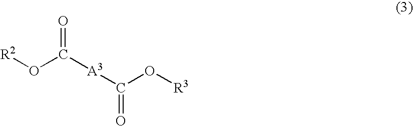
wherein R² and R³ each independently represents an allyl group or a methallyl group and A³ represents an organic residue derived from a divalent carboxylic acid or dicarboxylic anhydride having an alicyclic structure and/or an aromatic ring structure; 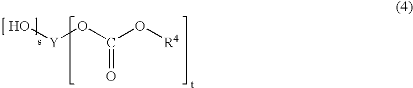
wherein Y represents one or more organic residues derived from a polyhydric alcohol having 2 to 20 carbon atoms and containing n hydroxyl groups, n represents an integer of 2 to 6, each R⁴ independently represents an allyl or a methallyl group, s is an integer of 0 to n-1, t is an integer of 1 t n, and s+t=n.

7. A plastic lens composition according to claim 6, which comprises from 10 to 80 wt % of the plastic lens material comprising at least one group represented by the formula (1) as a terminal group and a group represented by the formula (2) as a repeating unit, from 10 to 80 wt % of the component (β) and from 10 to 80 wt % of the component (γ), based on all curable components.

8. A plastic lens composition comprising a plastic lens material according to claim 1, the following component (β) and the following component (δ):
Component (β)
at least one compound selected from the compounds represented by the following formula (3);
Component (δ)
at least one monofunctional compound: 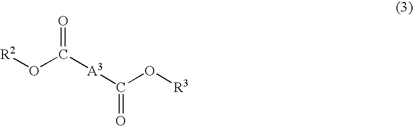
wherein R² and R³ each independently represents an allyl group or a methallyl group and A³ represents an organic residue derived from a divalent carboxylic acid or dicarboxylic anhydride having an alicyclic structure and/or an aromatic ring structure.

9. A plastic lens composition according to claim 8, which comprises from 10 to 80 wt % of the plastic lens material comprising at least one group represented by the formula (1) as a terminal group and a group represented by the formula (2) as a repeating unit, from 10 to 80 wt % of the component (β) and from 1 to 20 wt % of the component (δ), based on all curable components.

10. A plastic lens composition comprising a plastic lens material according to claim 1, the following component (β), the following component (γ) and the following component (δ):
Component (β)
at least one compound selected from the compounds represented by the following formula (3);
Component (γ)
at least one compound selected from the compounds represented by the following formula (4);
Component (δ)
at least one monofunctional compound: 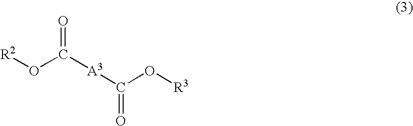
wherein R² and R³ each independently represents an allyl group or a methallyl group and A³ represents an organic residue derived from a divalent carboxylic acid or dicarboxylic anhydride having an alicyclic structure and/or an aromatic ring structure; 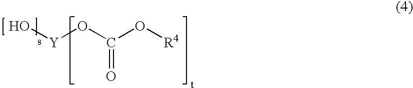
wherein Y represents one or more organic residues derived from a polyhydric alcohol having 2 to 20 carbon atoms and containing n hydroxyl groups, n represents an integer of 2 to 6, each R⁴ independently represents an allyl group or a methallyl group, s is an integer of 0 to n-1, t is an integer of 1 to n, and s+t=n.

11. A plastic lens composition according to claim 10, which comprises from 10 to 80 wt % of the plastic lens material comprising at least one group represented by the formula (1) as a terminal group and a group represented by the formula (2) as a repeating unit, from 8 to 80 wt % of the component (β), from 8 to 80 wt % of the component (γ) and from 1 to 20 wt % of the component (δ), based on all curable components.

12. A plastic lens composition according to claim, having a viscosity at 25° C. of 500 mPa.s or less.

13. A plastic lens composition according to claim, which comprises 0.1 to 10 parts by weight of at least one radical polymerization initiator per 100 parts by weight of all curable components in the plastic lens composition.

14. A plastic lens composition according to claim 13, wherein the at least one radical polymerization initiator is a compound having a structure represented by the following formula (90): 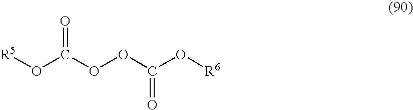
wherein R⁵ and R⁶ each independently represents at least one member selected from the group consisting of an alkyl group have 1 to 10 carbon atoms, a substituted alkyl group, a phenyl group and a substituted phenyl group.

15. A plastic lens obtained by curing a plastic lens composition according to claim.

16. A process for producing a plastic lens, comprising curing a plastic lens composition according to claim.

17. A process according to claim 16, wherein the plastic lens composition is cast molded at a curing temperature of 30 to 120° C. for a curing time of 0.5 to 100 hours.
